(19) United States
(12) Patent Application Publication
(10) Pub. No.: US 2026/0291884 A1
(43) Pub. Date: Sep. 24, 2026

(54) SYSTEM

(71) Applicant: SoftBank Group Corp., Tokyo (JP)

(72) Inventor: Hiroaki MASAKI, Tokyo (JP)

(73) Assignee: SoftBank Group Corp., Tokyo (JP)

(21) Appl. No.: 19/566,413

(22) Filed: Mar. 13, 2026

(30) Foreign Application Priority Data
Mar. 19, 2025 (JP) 2025-044918

(51) Int. Cl. H04L 51/02; G06F 9/54; G06N 3/045

(52) U.S. Cl. CPC H04L 51/02; G06F 9/542; G06N 3/045; G06F 2209/544

(57) ABSTRACT

A system includes a processor that is configured to: acquire audio data and convert the audio data into text data using a speech recognition technique; store the converted text data in a recording medium; generate a prompt for instructing a generative AI model to generate a summary based on the stored text data; input the prompt into the generative AI model; and transmit information via a network in order to share the generated summary immediately.

### CROSS-REFERENCE TO RELATED APPLICATION

This application is based on and claims priority under 35 USC 119 from Japanese Patent Application No. 2025-044918 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

In conventional meeting support systems, the creation and distribution of minutes largely depend on manual operations by users. A user is typically required to manually transcribe audio data of a meeting into text, summarize the transcribed text based on the content of the meeting, and then manually distribute the summary to other participants by email or a communication tool. Such manual work is time-consuming and error-prone, and may cause delays in sharing important decisions and action items. Even when speech recognition techniques are introduced, the resulting text data often remains as raw transcripts that are not summarized, and the user still needs to read the entire transcript and manually prepare a concise summary. Furthermore, there is often no integrated mechanism for automatically prompting a generative AI model to generate a summary based on stored text data and immediately sharing the generated summary via a network with user terminals. Therefore, there is a need for a system capable of automatically converting audio data into text data, storing the text data, automatically generating a suitable prompt for a generative AI model based on the stored text data to obtain a summary, and immediately sharing the generated summary via a network, thereby reducing the burden on the user and improving the efficiency and timeliness of information sharing.

### SUMMARY

In order to solve the above-described problems, a system according to one embodiment of the present invention comprises a processor, wherein the processor is configured to acquire audio data and convert the audio data into text data using a speech recognition technique, store the converted text data in a recording medium, generate a prompt for instructing a generative AI model to generate a summary based on the stored text data, input the prompt into the generative AI model, and transmit information via a network in order to share the generated summary immediately. In one aspect, the processor is configured to generate the prompt for instructing the generative AI model to generate the summary based on content of the text data, and cause the summary to be generated by using the prompt. In another aspect, the processor is configured to transmit a notification to a user terminal in order to share the generated summary immediately. By configuring the processor in this manner, the system automatically performs a series of processes from acquisition of audio data, conversion to text data, storage of the text data, generation of an appropriate prompt for a generative AI model, generation of a summary by the generative AI model, and immediate sharing of the generated summary via a network, thereby significantly reducing the manual work required of the user and enabling rapid and efficient sharing of meeting minutes and other summarized information.

The term “processor” refers to a hardware or software processing unit, such as a central processing unit (CPU), microprocessor, microcontroller, digital signal processor, or a combination of such units, that executes instructions to perform the functions described in the present specification and claims.
The term “audio data” refers to data representing sound, including but not limited to human speech captured by a microphone or other audio input device, and encoded in any suitable digital audio format.
The term “text data” refers to character-based digital data obtained by converting audio data using a speech recognition technique, and represents words, phrases, sentences, or other language units in a human-readable textual form.
The term “speech recognition technique” refers to a software or hardware based technique that analyzes audio data and automatically converts the audio data into corresponding text data, and may include cloud-based speech recognition services, on-device speech recognition engines, or combinations thereof.
The term “recording medium” refers to any tangible or non-transitory storage medium capable of storing digital data, including but not limited to semiconductor memory, magnetic storage, optical storage, or a storage area provided by a networked storage system or cloud storage service.
The term “generative AI model” refers to an artificial intelligence model, such as a neural network-based language model, that is configured to generate text, including summaries, in response to input data and instructions, based on patterns learned from training data.
The term “prompt” refers to an input text or structured instruction data that is provided to the generative AI model to specify a desired operation or output, such as instructing the generative AI model to generate a summary based on given text data.
The term “summary” refers to text generated by the generative AI model that condenses and abstracts content of the text data, including key points, decisions, or other important information, in a shorter and more concise form than the original text data.
The term “network” refers to any communication network that enables data transmission between the system and external devices or services, including but not limited to the Internet, local area networks (LAN), wide area networks (WAN), wireless networks, or combinations thereof.
The term “user terminal” refers to an information processing device operated by a user, such as a personal computer, smartphone, tablet, or other communication device, that is capable of receiving notifications and displaying the generated summary or related information.
The term “notification” refers to information transmitted from the system to a user terminal via a network, for the purpose of informing the user that a summary has been generated or is available, and may include message content, links, or metadata suitable for immediate access to the summary.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

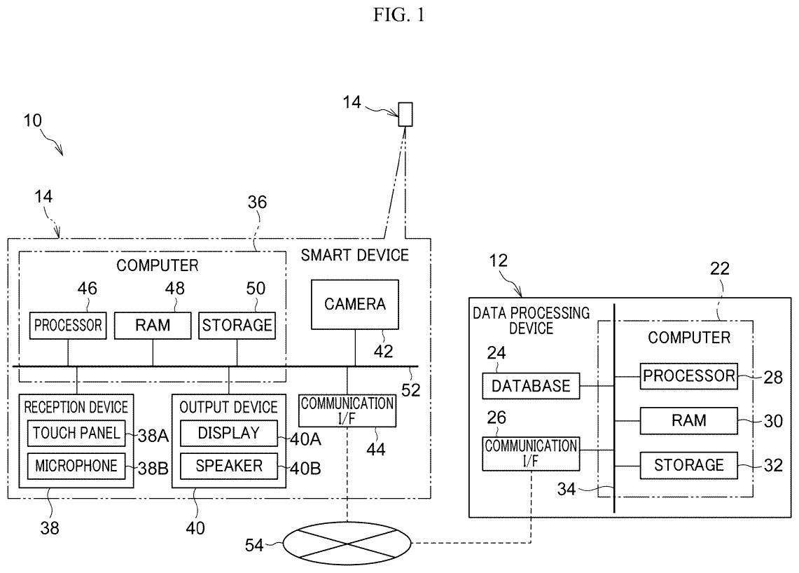

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

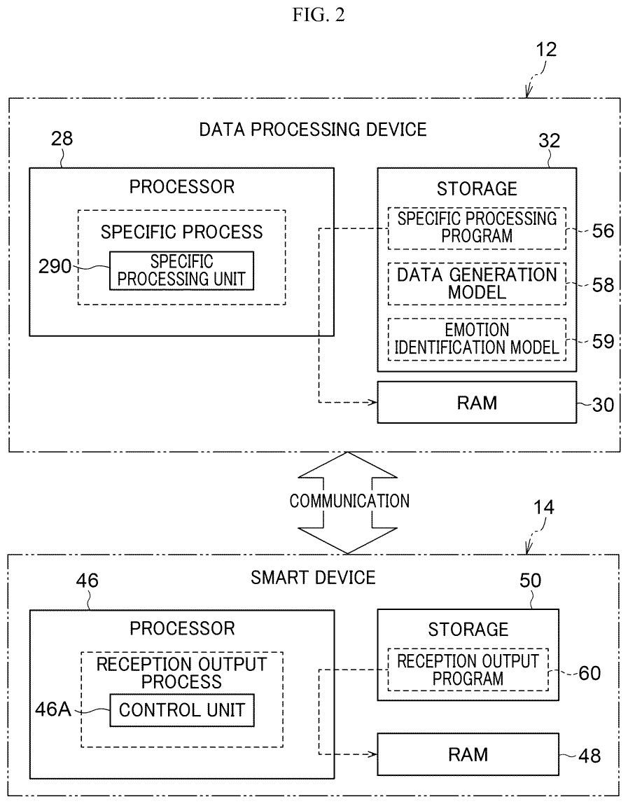

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional meeting-support systems that capture and process audio information typically perform a sequence of loosely coupled operations: recording audio, applying speech recognition, storing a transcript, and optionally generating a static summary. In many implementations, each operation is handled as an isolated function call or as a batch process, and the system logic merely passes raw data from one component to another without intelligently adapting to the characteristics of the data or to user-driven analysis requests. As a result, such systems exhibit several technical deficiencies from the viewpoint of computer technology.
First, existing systems often treat the speech recognition output as a passive text artifact, without structuring the character information and associated attribute information in a manner that facilitates efficient retrieval, re-use, and further machine processing. Unstructured or weakly structured storage of long-form character information leads to inefficient database operations, increased latency when retrieving and reprocessing transcripts, and difficulties in reliably associating multiple generated outputs (such as multiple summaries or analyses) with the same underlying communication event. This degrades the overall performance and scalability of server-side processing.
Second, when generative AI models are used, conventional systems typically employ fixed or manually crafted prompts that do not take into account the length, content, or metadata of the underlying transcript. Such static prompts fail to optimize the use of limited context windows and token budgets of the generative AI model, and may cause truncation of important parts of the character information, redundant processing, or low-quality output. This results in inefficient utilization of computational resources, unnecessary network traffic between the server and the generative AI model provider, and inconsistent quality of generated summaries and analyses.
Third, many systems generate a single, monolithic summary that is not designed for iterative, user-driven analysis. When a user later requests a different viewpoint or additional analysis (for example, extraction of action items, unresolved issues, or items for the next meeting), conventional solutions often require the entire pipeline—data retrieval, prompt construction, and model invocation—to be manually reconfigured or repeated in an ad hoc manner. This lack of an integrated mechanism for receiving additional prompt sentences and linking them with stored character information causes redundant computations, increased processing time, and complex application logic on both the server and the user terminal side.
Fourth, the presentation of generated information is frequently handled as plain text, without generating structured data that is optimized for display control on heterogeneous user terminal devices. Because the server does not produce structured representations that distinguish, for example, decisions, action items, and matters to be considered in subsequent communication events, the user terminal must perform additional parsing or heuristic processing, which is error-prone and may lead to inconsistent user interfaces. This imposes additional computational load on terminals with limited resources and complicates synchronization of views across multiple devices.
Accordingly, there is a need for a computer-implemented system that improves the way a processor acquires audio information, converts it into character information, structures and stores that information, dynamically generates and updates prompt sentences for a generative AI model based on the characteristics of the stored data and user requests, and generates structured output suitable for efficient server-side distribution and terminal-side display control. The technical problem to be solved is to provide an integrated, server-centric processing architecture that reduces redundant processing, optimizes the interaction with a generative AI model, enhances data organization and retrieval, and improves the efficiency, responsiveness, and reliability of the overall computing system when handling communication-event transcripts and related analyses.

The specific processing by the specific processing unit 290 of the data processing device 12 in Example 1 is realized by the following means.

The present invention provides a server comprising a processor and a storage device, the processor being configured to acquire audio information representing a communication event, execute speech recognition processing on the audio information to convert the audio information into character information, structure and store, in the storage device, the character information together with attribute information associated with the audio information including at least identification information of the communication event, temporal information, and participant information, acquire, from the storage device, the character information corresponding to the communication event and dynamically generate, based on at least one of a length and a content of the character information, a prompt sentence to be input to a generative AI model, input the prompt sentence and the character information into the generative AI model to cause the generative AI model to generate at least one of summary information and additional analysis information, store the generated summary information and the additional analysis information in the storage device in association with the identification information of the communication event, transmit, through a communication network and on the basis of destination information associated with a user terminal device, the generated summary information and the additional analysis information as notification information for immediate distribution to the user terminal device, and receive, from the user terminal device, request information including an additional prompt sentence defining additional analysis conditions for the character information, reacquire, from the storage device, the character information corresponding to the communication event, input the reacquired character information together with the additional prompt sentence into the generative AI model, and thereby regenerate the additional analysis information as structured data suitable for display control by the user terminal device. This enables improved computer operation by integrating structured storage of transcript data, adaptive prompt construction, and iterative interaction with the generative AI model on the server side, thereby reducing redundant processing, optimizing use of model context and network resources, and providing structured outputs that can be efficiently rendered and distinguished as decisions, action items, and future matters on heterogeneous user terminal devices.

The term “audio information” refers to digital data representing sound associated with a communication event, including at least speech signals captured by an input device such as a microphone and encoded in a machine-readable format.
The term “communication event” refers to an occurrence in which two or more participants, or one participant and a medium, exchange information using spoken language, including but not limited to a meeting, a conference, a call, a seminar, or an interview.
The term “speech recognition processing” refers to a computational procedure that analyzes audio information and converts the audio information into character information using an algorithm or a software component configured for automatic speech recognition.
The term “character information” refers to machine-readable textual data obtained by converting audio information through speech recognition processing, and representing the content of the communication event as a sequence of characters, words, or symbols.
The term “attribute information” refers to metadata associated with character information or audio information, including at least identification information of a communication event, temporal information, participant information, and any other contextual information used for storage, retrieval, or processing.
The term “identification information of the communication event” refers to data that uniquely distinguishes one communication event from another, such as an event identifier, a session identifier, or a combination of creation time and source identifiers.
The term “temporal information” refers to data indicating time-related aspects of a communication event or associated information, including at least a start time, an end time, timestamps, or duration values.
The term “participant information” refers to data indicating entities participating in a communication event, including at least names, identifiers, roles, or contact information of human users or automated agents.
The term “storage device” refers to a hardware or virtual component capable of non-transitory storage of data, including but not limited to a magnetic storage unit, a solid-state storage unit, a memory device, or a network-accessible data repository.
The term “structured information” refers to data organized according to a predefined schema or data model, such as records, fields, objects, or key-value pairs, enabling efficient storage, retrieval, and processing by a computing system.
The term “generative AI model” refers to a machine-learned computational model configured to generate new data, such as text, based on input data and a prompt sentence, and including at least a neural network model trained on language data.
The term “prompt sentence” refers to instruction information represented as text that is provided as input to a generative AI model, and that specifies a requested operation, output format, or analysis to be performed on character information.
The term “summary information” refers to text or structured data generated by a generative AI model that condenses character information by extracting or abstracting important content from the communication event.
The term “additional analysis information” refers to data generated by a generative AI model other than summary information, including at least extracted action items, decisions, unresolved matters, topics, or categorizations derived from character information.
The term “dynamic generation of a prompt sentence” refers to a process in which a processor constructs or modifies a prompt sentence at run time based on one or more characteristics of character information or attribute information, such as length, content, or metadata.
The term “destination information” refers to data used to determine a transmission target for notification information, including at least an address, an identifier, or a routing parameter associated with a user terminal device or a user account.
The term “notification information” refers to data transmitted through a communication network to a user terminal device to inform a user of generated summary information or additional analysis information, and including at least the generated data or a reference thereto.
The term “communication network” refers to an infrastructure enabling data exchange between a server and one or more user terminal devices, including but not limited to local area networks, wide area networks, wireless networks, or public packet-switched networks.
The term “user terminal device” refers to a computing device operated by a user, including but not limited to a smartphone, a tablet, a personal computer, or any other device configured to send and receive information via a communication network and to present information to the user.
The term “request information” refers to data transmitted from a user terminal device to a server to request processing by the server, and including at least an identifier of a communication event and an additional prompt sentence.
The term “additional prompt sentence” refers to a prompt sentence included in request information from a user terminal device, which defines additional analysis conditions or alternative viewpoints for processing character information by a generative AI model.
The term “structured data suitable for display control” refers to data organized in a way that explicitly distinguishes elements such as decisions, action items, and matters to be considered, enabling a user terminal device to control layout, emphasis, and grouping for presentation.
The term “display control information” refers to data transmitted from a server to a user terminal device, including structured data and any associated directives that cause the user terminal device to render summary information or additional analysis information in a specified format or arrangement.
The term “decisions” refers to outcomes, resolutions, or agreed-upon conclusions identified within character information or generated information that indicate what has been determined during a communication event.
The term “action items” refers to tasks or responsibilities identified within character information or generated information that specify actions to be performed, and that may include associated assignees and due dates.
The term “matters to be considered in a subsequent communication event” refers to topics, issues, or questions identified within character information or generated information that are not resolved in a current communication event and are intended for discussion or handling in a later communication event.

In one embodiment, a server, one or more terminals, and one or more users cooperate to implement the claimed system. The server includes at least one processor, a main memory, a non-transitory storage device, and a network interface. The terminal includes a processor, a memory, a microphone, a display, and a network interface. The user operates the terminal to initiate, control, and review the processing of communication events such as meetings or calls.
The server executes a server application on an operating system such as a general-purpose server operating system. The server application is implemented, for example, using a web framework and a database management system. The server uses a speech recognition engine, which may be implemented as a local software library or as access to an external speech recognition service, and a generative AI model, which may be implemented as a locally deployed neural network model or as access to a remote inference service. The server stores audio information, character information, attribute information, summary information, and additional analysis information in the storage device using structured data formats managed by the database management system.
The terminal executes a recording and communication application on a terminal operating system. The terminal uses an audio capture API (for example, a platform-provided media recording API) to sample analog audio signals from the microphone and encode the sampled signals into digital audio information in a standardized format such as linear PCM or compressed audio. The terminal also executes a user interface component that displays lists of communication events, summaries, and analyses, and that allows the user to supply natural-language instructions as a prompt sentence.
The user operates the terminal to start and stop recording and to designate information about the communication event such as a title or participants. The user also operates the terminal to initiate generation of a summary or of additional analyses. The user can input a custom prompt sentence, such as:
“Summarize the following meeting transcript in English. Focus on decisions, action items, and deadlines. Keep the summary under 300 words.” or
“From this meeting transcript, list only the action items, including the responsible person and due date if available.” or
“Identify the top 10 unresolved issues mentioned in this meeting and describe each issue in one sentence for the next meeting preparation.”
The server receives these prompt sentences as part of request information and incorporates them into the generative AI processing.
The server acquires audio information that represents a communication event from the terminal via the network interface. The server stores the raw audio information in the storage device and associates it with attribute information, including an identifier of the communication event, timestamps, and identifiers for the user and participants. The server executes speech recognition processing on the audio information using a speech recognition engine. The speech recognition engine implements a statistical or neural network-based model that segments the audio into frames, extracts acoustic features (for example, Mel-frequency cepstral coefficients or log-mel spectrograms), and computes a sequence of probability distributions over phonemes or characters which are decoded into character information using a decoding algorithm such as beam search with a language model. The server then obtains character information representing the transcript of the communication event.
The server structures the character information and the attribute information in a data schema optimized for later retrieval and processing. For example, the server stores, in a relational or document-oriented database, records that include fields for a communication event identifier, a start time, an end time, per-segment timestamps, speaker labels, a text field for the full transcript, and a separate structure for granular segments (such as utterances) with start and end times. The server optionally compresses long text fields and uses indexing on the communication event identifier and timestamps to accelerate queries. This structured storage allows the server to retrieve only relevant segments of character information for a given analysis, which reduces memory usage and database I/O.
The server configures a generative AI model to perform summary generation and additional analyses. In one embodiment, the generative AI model is implemented as a transformer-based neural network. The generative AI model includes an input embedding layer that maps tokens of character information and prompt sentences to numerical vectors, a plurality of transformer blocks each including multi-head self-attention mechanisms and position-wise feed-forward networks, and an output projection layer that maps internal hidden states to probability distributions over an output vocabulary. The generative AI model is trained beforehand on a large corpus of textual data, including transcribed dialogs and documents, by minimizing a loss function such as cross-entropy between predicted tokens and ground-truth tokens using an optimization method such as stochastic gradient descent or Adam. The training process updates the model's weight parameters by backpropagating gradients computed on mini-batches of training examples, and may incorporate regularization techniques such as dropout, label smoothing, or weight decay.
The server uses the generative AI model in an inference mode. The server tokenizes the prompt sentence and the character information into subword tokens using a predetermined tokenizer, converts the tokens into embedding vectors, and feeds these vectors through the transformer layers. The generative AI model computes attention scores that allow the model to focus on specific segments of the transcript that are relevant to the instructions encoded in the prompt sentence. The server then performs auto-regressive generation of output tokens, where the generative AI model repeatedly computes a probability distribution over the next token conditioned on the prompt and the tokens generated so far, and selects tokens according to a decoding strategy such as greedy decoding, beam search, or nucleus sampling. The server converts the generated tokens back into text to obtain summary information or additional analysis information.
The server does not use a single static prompt for all communication events. Instead, the server dynamically generates a prompt sentence based on the length and content of the character information and on attribute information. The server analyzes the character information to determine properties such as total token count, number of segments, presence of specific keywords, and distribution of participant turns. Based on these properties, the server selects a prompt template and parameters such as desired summary length, emphasis on decisions or action items, and inclusion of unresolved matters. The server generates an instruction text that explicitly constrains the generative AI model to produce a structured output. For example, the server may generate a prompt sentence such as:
“The following is a transcript of a project status communication event. Generate a bullet-point summary that includes three sections: (1) Decisions, (2) Action items with assignees and due dates, and (3) Matters to be discussed in the next communication event. Use clear and concise language and do not exceed 400 words. Transcript: [transcript text].” By computing this prompt content automatically according to programmatic rules rather than merely forwarding user-supplied text, the server improves the quality and consistency of the generative AI output and reduces the need for manual prompt tuning. The server also accounts for the token limit of the generative AI model by computing an estimate of token usage and, when necessary, selecting or compressing transcript segments so that the most relevant segments are preserved while remaining within the model's context window. This computation reduces the risk of truncation and leads to more efficient use of processing resources.
The server stores the generated summary information and additional analysis information in the same structured data schema as the character information, associating each generated output with the communication event identifier and with metadata such as generation time, generative AI model identifier, decoding parameters, and the prompt sentence used. The server uses separate tables or collections to store different types of analyses, such as summaries, action item lists, decision lists, and unresolved matter lists. This structure allows incremental addition of analyses over time without updating the original transcript.
The server transmits summary information and additional analysis information as notification information to terminals via the communication network. The server generates structured data for display control, for example a JSON-like internal representation that includes explicit fields for “decisions,” “action_items,” and “next_meeting_matters,” each containing a list of text entries and optional metadata such as assignee identifiers and due dates. The server transforms this internal structure into a protocol message, which the terminal can parse without further natural-language processing. Because the server generates structured display control information, the terminal can perform lightweight rendering of the content without expensive local text analysis.
The terminal receives the notification information and display control information from the server and displays the structured content using layout components that correspond to fields such as “decisions” and “action_items.” The terminal processor interprets the display control information to place each category of information in a separate section with appropriate visual emphasis. The terminal may also provide interactive controls that allow the user to filter, search, or export specific categories. The use of structured data reduces computational load on the terminal, improves responsiveness, and allows consistent presentation across different terminal types.
The user may request additional analyses on the same communication event by supplying an additional prompt sentence. For example, the user may input:
“For the same transcript, extract only the risks and mitigation strategies mentioned, and present them as paired bullet points.”
The terminal sends request information, including the communication event identifier and the additional prompt sentence, to the server. The server reacquires the character information and associated attribute information from the storage device and generates a new composite prompt sentence that includes system-level instructions and the user's additional prompt sentence. The server then runs the generative AI model again to produce additional analysis information that is specialized to the requested viewpoint. The server stores this analysis information with separate identification, and transmits it to the terminal as structured data for display.
The server improves computer technology in several ways. By storing character information and attribute information in a structured schema tailored to communication events, the server reduces query time and memory footprint when retrieving relevant transcript segments. By dynamically generating prompt sentences based on transcript characteristics and user requests, the server optimizes token usage in the generative AI model, reduces unnecessary network traffic and inference time, and increases output accuracy by ensuring that the model receives well-formed instructions that are adapted to the specific context. The server's design avoids mere automation of human note-taking and instead provides an adaptive computational process that coordinates speech recognition, structured storage, and transformer-based text generation.
In one variant, the server hosts the generative AI model locally on hardware accelerators such as graphics processing units. The server divides the transformer model into layers distributed across multiple accelerators and uses parallel processing to compute the attention and feed-forward operations more quickly. The server uses a runtime engine to schedule inference requests and to batch multiple generative requests when possible, thereby increasing throughput. The server monitors latency and computational load statistics and adjusts decoding parameters such as maximum tokens and beam width dynamically to maintain response time constraints. These operations improve the efficiency of the computing system and are not dependent on any particular business process.
In another variant, the server uses a hybrid rule-based and generative architecture. The server first applies deterministic rules or filters to the character information to identify candidate segments that likely contain decisions, action items, or unresolved matters. These rules may involve keyword matching, pattern recognition of phrases indicating agreements or tasks, and position-based heuristics. The server then constructs prompt sentences that explicitly refer to these pre-identified segments, instructing the generative AI model to refine and structure them. By filtering and structuring the input prior to generative processing, the server reduces the volume of data that needs to be encoded by the generative AI model, which lowers computation time and improves the precision of extracted information. This non-conventional division of labor between rule-based filtering and generative modeling leads to improved technical performance compared to systems that rely solely on raw transcripts.
In a further embodiment, the server modifies the generative AI model's input using special control tokens that represent categories such as “DECISION,” “ACTION_ITEM,” and “NEXT_MEETING.” The server inserts these control tokens into the prompt sentence or into the segment delimiters of character information before tokenization. The generative AI model, which has been fine-tuned on training data containing such control tokens, uses them as features to organize attention patterns and to generate outputs in categorized form. This internal conditioning reduces ambiguity and increases the likelihood that the generated information will be correctly partitioned into decisions, action items, and matters for subsequent communication events. The use of control tokens and fine-tuning procedures is a specific technical method that affects the internal behavior of the neural network, improving its ability to generate structured outputs required by the system.
The server can employ various learning procedures when training or fine-tuning the generative AI model. These procedures may include supervised fine-tuning on domain-specific transcripts and reference summaries, where the server minimizes a cross-entropy loss between generated and reference tokens; reinforcement learning with human feedback, where the server uses a reward signal based on human evaluation of summary quality to update the model parameters; and data augmentation, where the server automatically generates paraphrased transcripts, truncated versions, or reorganized sequences to expose the model to a wider variety of input conditions. By applying these techniques, the server obtains a generative AI model that is more robust to variations in transcript content and can maintain high-quality outputs even when transcripts are long or noisy.
Alternative embodiments may vary the types of storage devices, databases, and network protocols without departing from the core processing architecture. For example, the storage device may include distributed object storage and the database may be a key-value store or a columnar database. The network interface may support secure transport protocols and may be deployed across multiple data centers for redundancy. The server may also implement caching mechanisms that store frequently accessed transcripts and summaries in a memory cache, reducing disk access and further improving response time.
By combining these hardware, software, and algorithmic components into a coherent architecture that structures, processes, and reuses communication-event transcripts, the system achieves technical effects such as reduced latency, improved accuracy of summary and analysis generation, reduced communication load between the server and generative AI processing resources, and decreased processing load on terminals. These effects arise from the specific data structures used for storage, the dynamic generation of prompt sentences, the interaction with a transformer-based generative AI model, and the generation of structured display control information that guides terminal-side rendering.

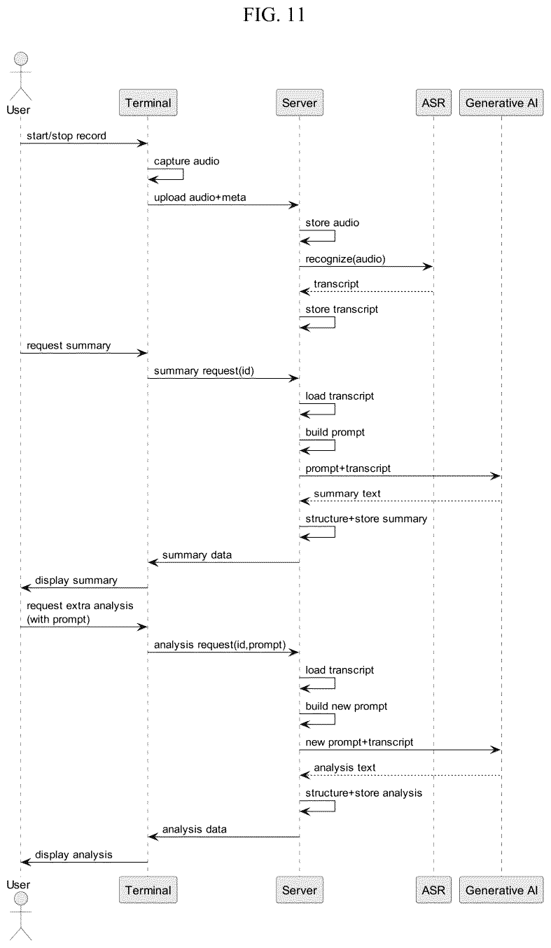

The following describes the processing flow using FIG. 11.
Step 1:
The user operates the terminal to start recording a communication event.
The terminal receives input as analog audio signals from a microphone and additional metadata entered by the user such as a tentative title and participant list.
The terminal uses an audio capture API to sample the analog audio, performs analog-to-digital conversion, and encodes the samples into a digital audio file (for example, linear PCM or compressed audio).
The terminal writes the encoded audio data and the metadata into local storage as a temporary file and a metadata record.
The terminal sends an upload request to the server over a network, where the request includes the audio file and the metadata as the output of this step.
Step 2:
The server receives the upload request from the terminal.
The input to this step is the digital audio file and the associated metadata transmitted by the terminal.
The server validates the request headers, checks file type and size, and stores the raw audio file into a storage device, creating a unique communication event identifier and linking the metadata to this identifier.
The server records the storage location (for example, a file path or object key) and the communication event identifier as structured data in a database.
The server outputs a confirmation response to the terminal, including the communication event identifier as the output of this step.
Step 3:
The server performs audio format inspection and conversion.
The input to this step is the stored audio file associated with the communication event identifier.
The server uses a media processing component to inspect properties of the audio file, such as codec, sample rate, bit depth, and number of channels, and compares them with the required format of the speech recognition engine.
The server, when necessary, converts the audio file to a required format (for example, mono, 16 kHz linear PCM) by applying resampling, channel mixing, and re-encoding operations.
The server stores the converted audio file in the storage device and updates the database record to reference the converted file as the output of this step.
Step 4:
The server executes speech recognition processing to obtain character information.
The input to this step is the converted audio file linked to the communication event identifier.
The server feeds the audio data into a speech recognition engine, which extracts acoustic features, calculates probabilistic outputs over phonetic units, and decodes them into a sequence of characters or words.
The server performs post-processing on the decoded text, such as punctuation insertion, sentence segmentation, and optional speaker diarization based on energy levels or model-based speaker embedding comparison.
The server stores the resulting character information and segment-level timestamps in the database as structured fields and associates them with the communication event identifier as the output of this step.
Step 5:
The server enriches and structures attribute information for the communication event.
The input to this step is the character information produced in Step 4 and the metadata stored in earlier steps.
The server generates attribute information such as start time and end time of the communication event derived from timestamps, participant identifiers derived from metadata, and segment boundaries derived from speech recognition time markers.
The server organizes the character information and attribute information into a data schema that includes a main transcript record and associated segment records, and it indexes the fields by communication event identifier and timestamps.
The server writes the structured records into the database and outputs a fully indexed transcript entry that is ready for retrieval in later steps.
Step 6:
The user initiates a summary generation request through the terminal.
The input to this step is the list of communication events displayed on the terminal, which the terminal obtains by querying the server.
The user selects a communication event and optionally enters summary preferences or a custom prompt sentence, such as a desired focus or length.
The terminal packages the selected communication event identifier and any user-provided prompt sentence into a request message.
The terminal sends this request message to the server as the output of this step.
Step 7:
The server retrieves transcript data for generative processing.
The input to this step is the summary generation request containing the communication event identifier and optional user-provided prompt sentence.
The server queries the database for the main transcript record and associated segment records that correspond to the communication event identifier.
The server assembles the character information into a single logical transcript string or into a structured representation, and it may compute statistics such as transcript length, number of segments, and distribution of speakers.
The server outputs a combined data object containing the transcript text, attribute information, and any user-provided prompt sentence as the output of this step.
Step 8:
The server dynamically generates a base prompt sentence for a generative AI model.
The input to this step is the combined data object containing transcript text, attribute information, and optional user instructions.
The server analyzes the transcript length and content to determine an appropriate summary length, target categories (for example, decisions, action items, unresolved matters), and whether to truncate or segment the transcript for model input.
The server composes a base instruction sentence that specifies the type of output and the structure required, such as:
“The following is a transcript of a business communication event. Generate a summary with three sections: (1) Decisions, (2) Action items with assignees and due dates, and (3) Matters to be discussed in the next communication event. Use clear bullet points and keep the summary under 400 words. Transcript: [transcript text].”
The server merges the base instruction with any user-provided prompt sentence, resolves conflicts between instructions according to internal priority rules, and outputs a finalized prompt sentence tailored to the specific transcript as the output of this step.
Step 9:
The server invokes the generative AI model to generate summary information and/or additional analysis information.
The input to this step is the finalized prompt sentence and the transcript text derived in Step 8.
The server tokenizes the prompt sentence and the transcript into subword tokens, converts these tokens into embedding vectors, and forwards the vectors through a transformer-based neural network that implements the generative AI model.
The server causes the generative AI model to compute attention over the tokens and to generate output tokens one by one according to an auto-regressive decoding algorithm, using configured parameters such as maximum token count and temperature.
The server decodes the output tokens into human-readable text that forms summary information or additional analysis information, and outputs this text and optional intermediate structured content (for example, identified categories or section markers) as the output of this step.
Step 10:
The server structures and stores the generated summary information and additional analysis information.
The input to this step is the generated text output from the generative AI model and the communication event identifier.
The server parses the generated text according to known section markers or delimiters in the prompt sentence, and converts the text into structured data elements such as separate lists for decisions, action items, and future matters.
The server stores these structured data elements in dedicated tables or collections within the database, each record linked to the communication event identifier, the generative AI model identifier, the generation time, and the prompt sentence used.
The server outputs a stored representation of the structured summary information and additional analysis information as the output of this step.
Step 11:
The server prepares notification information and display control information for the terminal.
The input to this step is the structured summary information and additional analysis information stored in Step 10, along with destination information associated with the user terminal.
The server packages the structured data into a message that includes display control information, such as explicit fields for “decisions,” “action_items,” and “next_meeting_matters,” and includes layout and ordering instructions suitable for the terminal.
The server transmits the notification information and display control information through a communication network to the terminal identified by the destination information.
The server outputs the transmitted message as the output of this step.
Step 12:
The terminal receives and displays the structured summary information.
The input to this step is the notification information and display control information transmitted by the server.
The terminal parses the structured content and maps each category to corresponding user interface components, creating sections on the display for decisions, action items, and matters for the next communication event.
The terminal applies the display control information to set visual properties such as section titles, bullet lists, and highlighting of critical items, and renders the summarized content on the display.
The terminal outputs an interactive screen that allows the user to view, scroll, and optionally filter or share the generated information as the output of this step.
Step 13:
The user requests additional analysis using a new prompt sentence.
The input to this step is the displayed summary screen and an input field for additional instructions.
The user reads the summary and then types a new prompt sentence, for example: “From the same transcript, extract only the risks and corresponding mitigation strategies in paired bullet points.”
The terminal associates the new prompt sentence with the communication event identifier currently in view and forms request information that includes both.
The terminal sends this request information to the server as the output of this step.
Step 14:
The server performs iterative analysis based on the additional prompt sentence.
The input to this step is the request information containing the communication event identifier and the additional prompt sentence.
The server reacquires the stored transcript and attribute information from the database, optionally reuses or adjusts the base prompt templates, and constructs a new composite prompt sentence that combines system-level instructions with the user's additional prompt sentence.
The server re-invokes the generative AI model using this new composite prompt sentence and the transcript text, generating new additional analysis information, such as categorized lists of risks and mitigation strategies.
The server structures and stores this new additional analysis information in association with the communication event identifier and returns it to the terminal as structured data, which becomes the output of this step.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional systems that provide transcripts and summaries of audio content often rely on batch processing pipelines in which audio data is first recognized, then stored as a static transcript, and later post-processed to generate summaries. Such architectures are not optimized for low-latency interaction between speech recognition components, generative AI models, and terminal-side display control. As a result, these systems typically exhibit significant end-to-end delay, fragmented data management between transcripts and summaries, and poor synchronization between audio playback and textual information presented to users.
In many implementations, transcript data and summary data are handled as separate artifacts with no unified linkage to temporal metadata. The lack of fine-grained association with time information prevents accurate alignment of live captions and AI-generated summaries with the actual playback position of the audio information. Furthermore, prompt sentences used to invoke generative AI models are often statically defined or manually crafted, and are not dynamically adapted based on user preferences, playback context, or the temporal structure of the recognized text. This leads to redundant processing, suboptimal summarization quality, and increased computational overhead.
Additionally, known systems frequently treat generative AI models as an external, loosely coupled component. They do not provide a well-defined mechanism in the server to systematically segment recognized character information, automatically generate instruction-rich prompt sentences including summarization, explanation, or translation conditions, and manage the summarized character information together with the original character information in a single time-indexed data structure. This results in inefficiencies in memory usage, increased network traffic due to repeated transmission of similar data segments, and complexity in coordinating real-time updates to multiple terminal devices. From the perspective of computer technology, there is a need for an improved server-side processing architecture that: (i) tightly integrates speech recognition output, time-aligned transcript management, and generative AI-based summarization; (ii) automatically constructs and updates prompt sentences based on user-specified conditions and temporal context; (iii) maintains synchronized delivery of both raw character information and summarized character information to terminal devices; and (iv) supports low-latency, scalable notification to other devices or users. Such an architecture should enhance the efficiency, responsiveness, and scalability of the underlying data processing, thereby improving the functioning of the computer system itself rather than merely automating a human mental process.

The specific processing by the specific processing unit 290 of the data processing device 12 in Application Example 1 is realized by the following means.

The present invention provides a server comprising a processor configured to acquire audio information, convert the audio information into character information using a speech recognition technique, store the character information in a storage device in association with time information, generate a prompt sentence including an instruction statement specifying at least one of summarization conditions, explanation conditions, translation conditions, and expression conditions for at least a part of the stored character information, supply the prompt sentence together with the character information as input information to a generative AI model, obtain summarized character information output from the generative AI model in response to the prompt sentence, manage the summarized character information in association with a playback position of the audio information on the basis of the time information, and control transmission of the character information and the summarized character information to at least one terminal device and to at least one additional device or user via a communication path. This enables an integrated, time-indexed processing pipeline in which the server efficiently manages both transcript and summary data, dynamically adapts prompt sentences based on temporal and user-specified conditions, and delivers synchronized textual information with reduced latency and improved resource utilization, thereby improving the overall performance and technical operation of the computer system.

The term “audio information” refers to digital data representing sound, including but not limited to speech, music, and environmental noise, that is processed by a computer system for analysis, recognition, or playback.
The term “character information” refers to machine-readable text data obtained by converting audio information or other source data into sequences of characters, symbols, or codes suitable for storage, processing, and display.
The term “speech recognition technique” refers to a computational method or algorithm that analyzes audio information and converts the audio information into character information, including techniques implemented by software, firmware, or hardware components.
The term “storage device” refers to any computer-readable medium capable of storing data, including volatile memory, non-volatile memory, magnetic storage, optical storage, or solid-state storage, used to retain character information and associated metadata.
The term “time information” refers to temporal metadata associated with character information or audio information, including timestamps, time intervals, playback positions, or other indicators that allow alignment between the information and a temporal axis.
The term “prompt sentence” refers to an instruction string, message, or text input that is provided to a generative AI model and that specifies at least one processing condition, such as summarization, explanation, translation, or expression style, for character information.
The term “instruction statement” refers to a portion of a prompt sentence that explicitly directs the generative AI model to perform a particular operation, such as generating a summary, producing a simplified explanation, or creating a translation-based summary.
The term “summarization condition” refers to parameters or constraints that define how character information is to be condensed, including desired length, level of detail, target audience, or focus on particular topics.
The term “explanation condition” refers to parameters or constraints that define how character information is to be explained, including desired complexity level, use of examples, or adaptation to a specified knowledge level of a user.
The term “translation condition” refers to parameters or constraints that define how character information is to be translated, including a target language, degree of literalness, and whether summarization is to be combined with translation.
The term “expression condition” refers to parameters or constraints that define stylistic aspects of generated text, including tone, formality, terminology selection, or formatting preferences.
The term “generative AI model” refers to a computational model, such as a machine learning model or neural network, that generates new text data in response to input data, including large language models that produce summaries, explanations, or translations based on prompt sentences.
The term “summarized character information” refers to character information generated by a generative AI model that condenses or abstracts original character information while preserving essential content or meaning.
The term “playback position” refers to a point or interval along a temporal axis indicating a current or specified position within playback of audio information, which is used to align displayed character information with the audio information.
The term “communication path” refers to any wired or wireless data transmission medium or logical channel, including networks and protocols, through which the system transmits character information, summarized character information, or notification information.
The term “terminal device” refers to an endpoint computing apparatus, such as a mobile device, personal computer, or display device, that receives information from the system, performs local processing, and presents information to a user.
The term “caption region” refers to a designated display area on a terminal device in which character information corresponding to audio information is presented in synchronization with playback of the audio information.
The term “summary region” refers to a designated display area on a terminal device in which summarized character information is presented, including overviews or condensed descriptions of content associated with the audio information.
The term “notification information” refers to data representing a message, alert, or update that is generated for the purpose of sharing character information or summarized character information in real time with another device or another user.
The term “user” refers to a human operator or viewer who interacts with the terminal device, provides input conditions such as summarization or translation preferences, and consumes information presented by the system.

In one embodiment, a server executes a program that integrates speech recognition processing, time-indexed text management, and generative AI-based summarization in order to provide synchronized captions and summaries of audio information to one or more terminal devices.
The server operates on general-purpose computing hardware such as an x86_64 or ARM-based processor, main memory (RAM), non-volatile storage (for example, a solid-state drive), and a network interface for wired or wireless communication. The server runs an operating system such as a general-purpose server operating system and application software implemented using a web application framework such as a server-side framework, and optionally a microservice framework for scaling the speech recognition and generative AI modules.
The server uses a speech recognition module that may be implemented by invoking an external speech recognition API (for example, a generic cloud-based speech-to-text service) or by executing a local acoustic and language model stack based on a deep neural network. In a local implementation, the server uses a convolutional neural network (CNN) and recurrent neural network (RNN) or transformer-based acoustic model trained on mel-frequency cepstral coefficient (MFCC) features or log-mel spectrograms, combined with a language model such as a recurrent neural network language model or a transformer language model. The server converts raw audio waveforms into short-time frames (for example, 25 ms windows with 10 ms stride), computes spectral features, and then feeds the feature vectors into the acoustic model. The server decodes the resulting probability distributions using beam search with a lexicon and language model to output character sequences, thereby generating character information.
The server stores the character information in a storage device using a time-indexed data structure. The server associates each token, word, or sentence-level segment with time information such as a start timestamp and an end timestamp corresponding to positions in the original audio information. The server may maintain this information in a relational database table with fields such as segment_id, start_time, end_time, text, and source_audio_id, or in a document-oriented datastore with nested arrays of time-stamped text segments. By using this time-indexed data structure, the server enables efficient retrieval of text segments aligned with a given playback position or time interval.
The server generates a prompt sentence to be supplied to a generative AI model. The server selects a sequence of character information that corresponds, for example, to the most recent 30 to 90 seconds of the audio information based on the time information. The server then constructs a prompt sentence that includes an instruction statement specifying at least one of summarization conditions, explanation conditions, translation conditions, and expression conditions. The server may generate, for example, the following prompt sentences in plain text:
“Please summarize the following transcript in 3-4 concise sentences for a non-expert audience: [transcript text].”
“Summarize the following text in simple English for non-native speakers and highlight the main technical terms: [transcript text].”
“Translate and summarize the following English transcript into Japanese in 3-4 short sentences: [transcript text].”
“Explain the following transcript in simpler terms suitable for a beginner, using one concrete example: [transcript text].”
The server may adapt the instruction statement dynamically in response to user preferences received from terminal devices. For example, when a user selects a “simplified explanation” mode on a terminal, the server adds an explanation condition such as “explain this in simple terms” to the prompt sentence. When the user selects a translation language, the server adds a translation condition specifying a target language.
The server uses a generative AI model to generate summarized character information based on the prompt sentence and the selected character information. In one embodiment, the server invokes an external large language model via an API. In another embodiment, the server executes a local generative AI model on a computation device equipped with a graphics processing unit (GPU) such as a general-purpose GPU, or on specialized AI accelerators. The generative AI model may be a transformer-based neural network comprising multiple encoder and/or decoder layers, each layer including self-attention mechanisms, feed-forward networks, layer normalization, and residual connections.
The server encodes the input tokens representing the prompt sentence and the character information using an embedding layer that maps each token to a fixed-dimensional vector. The server then processes the sequence of embeddings through multiple transformer layers, where each layer computes attention scores between tokens to capture long-range dependencies. The generative AI model is trained using a large corpus of text with a next-token prediction objective or an instruction-following objective. During training, the server (or a training environment) uses a loss function such as cross-entropy loss between predicted token probabilities and ground truth tokens, and updates model parameters (weights of attention, feed-forward, and embedding layers) by backpropagation and an optimizer such as Adam or AdamW. Training may incorporate regularization techniques such as dropout, weight decay, and data augmentation (for example, back-translation or paraphrasing) to improve generalization. As a result of this training process, the generative AI model acquires non-trivial mapping rules between instruction-like prompt sentences and desired output behaviors (summarization, explanation, and translation summarization).
The server uses decoding algorithms such as beam search or top-k/top-p sampling during inference to generate output tokens. The server constrains generation based on summarization conditions, such as maximum length, focus on key entities, or domain-specific vocabulary, by adjusting decoding parameters (for example, length penalty, sampling temperature) and by including explicit control phrases in the prompt sentence. This leads to non-human-like, machine-optimized sequences of operations that reduce redundancy and improve coherence without simply mirroring human summarization strategies.
The server post-processes the summarized character information by aligning it with the time information of the underlying character information. The server associates each part of the summarized text with a representative timestamp, such as the midpoint or span of the original segments from which it was derived. The server may also perform text normalization, including punctuation adjustment, casing standardization, and segmentation into subtitle-length lines suitable for display on small screens. The server then stores the summarized character information in the storage device using a dedicated, time-indexed structure parallel to the structure used for the original character information.
The server transmits both the character information and the summarized character information to terminal devices via a communication path such as a packet-switched network using transport protocols. The server can use persistent connections such as WebSocket or protocols that support server-initiated updates to push new text segments to terminals with low latency. The server can also generate notification information for sharing at least one of the character information and the summarized character information with other devices or users. The server may compress payloads using text compression algorithms or binary serialization formats to reduce network load, and may batch multiple segments into a single message when doing so does not compromise synchronization. These optimizations reduce communication overhead and improve responsiveness.
The terminal executes a client application on a computing platform such as a smartphone, tablet, personal computer, or dedicated display device. The terminal includes a processor, memory, a display unit, audio output hardware, and a communication interface. The client application is implemented using a user interface framework such as a mobile UI toolkit or a web technology stack. The terminal receives messages from the server that contain the character information, summarized character information, and associated time information. The terminal parses the incoming data, stores it in local buffers, and schedules display operations based on a local playback clock.
The terminal presents the character information in a caption region of the display, aligned with the playback of the audio information. The terminal determines the current playback time of the audio information from its media player component, which decodes audio streams and outputs audio frames to the audio hardware. The terminal then selects segments from the time-indexed character information whose time ranges overlap the current playback time, and renders them in the caption region using a font size, color, and positioning suitable for readability. The terminal similarly presents the summarized character information in a summary region. The summary region may show the most recent summary segment, a rolling list of summaries, or user-selected summaries corresponding to earlier parts of the audio information.
The user interacts with the terminal to specify summarization conditions, explanation conditions, translation conditions, or expression conditions. For example, the user may select “simple English summary,” “detailed explanation,” or “translate to Japanese and summarize” from a settings interface. The terminal sends control information reflecting these user selections to the server. The server modifies subsequent prompt sentences accordingly, for instance by adding phrases such as “explain in simple terms with one example” or “translate into Japanese and then summarize in 3 sentences.” As a result, the generative AI model produces output that is customized to the user's preferences without requiring manual rewriting of prompt sentences for each segment.
The server reduces computational load and improves system performance by reusing time-indexed text segments rather than reprocessing entire transcripts. The server can restrict input to the generative AI model to only those segments that have not yet been summarized, identified by their time information and a processing-state flag. The server can store hashes or identifiers of processed segments to avoid redundant summarization for overlapping windows. This selective input reduces the size of the context window presented to the generative AI model, decreasing inference time and memory usage, which leads to faster response for terminals and lower hardware requirements.
The server improves data management by using unified, time-indexed structures for both original and summarized character information. This unification simplifies retrieval operations, journaling, backup, and caching because both levels of text data share a common indexing scheme. As a result, the server can quickly retrieve all text related to any given playback period, enabling efficient seeking, re-summarization, or alternative-view generation. This structured data management represents an improvement over conventional systems in which transcripts and summaries are stored in separate, loosely coupled repositories.
The server enhances technical performance by coordinating communication with multiple terminal devices and additional devices or users. When multiple users are consuming the same audio information, the server can generate summarized character information once and distribute it to all terminals and subscribers through multicast or broadcast mechanisms over application-layer protocols. This avoids duplicated generative AI processing and reduces overall CPU/GPU consumption. The server can also adapt transmission strategies based on network conditions, for example by reducing the frequency of summary updates for devices on constrained networks or by sending lower-resolution text batches, thereby reducing packet loss and improving perceived quality of service.
The described architecture provides improvements in processing speed, accuracy, and error reduction. By integrating time-indexed transcript management and generative AI summarization within the same server, the system eliminates the need for separate, sequential batch jobs. The server can start summarization as soon as a minimal amount of character information is available, without waiting for a complete transcript, thereby lowering end-to-end latency. The use of deep neural network-based speech recognition and generative models improves recognition and summarization accuracy compared with simple keyword extraction or rule-based methods, and the explicit use of time information reduces alignment errors between audio and displayed text.
The system goes beyond mere automation of human summarization by relying on complex model architectures, training procedures, and data structures that are specifically designed for machine execution. The neural networks use mathematical optimization, gradient-based learning, and attention mechanisms that are not practically executed by humans. The server's time-indexed, segment-based data management and its dynamic prompt construction logic are tailored to optimize machine computation, memory access patterns, and network transmission, thus improving the functioning of the computer system as a whole.
Alternative embodiments are possible. The server may execute the generative AI model entirely on-premises using one or more GPUs, or may distribute inference across multiple nodes in a cluster. The speech recognition module may employ different acoustic features, such as raw waveform convolutional encoders or filterbank features, and may use different decoding techniques such as connectionist temporal classification (CTC) decoding or attention-based sequence-to-sequence decoding. The generative AI model may be fine-tuned on domain-specific corpora, such as medical or legal transcripts, to improve summarization and explanation accuracy for specialized content.
The terminal may be embodied as a head-mounted display, a smart television, or an in-vehicle infotainment system. In such configurations, the caption region and summary region may be overlaid on video content, projected in an augmented reality field of view, or presented on a dashboard display. The server and terminal may cooperate to adapt display parameters in response to environmental conditions, such as screen size or viewing distance, by adjusting font sizes or number of lines displayed.
In another embodiment, the server may generate multiple types of summarized character information for the same segment of character information, for example a short summary for quick viewing and a longer explanation with definitions of technical terms. The server can associate these variants with different summary types in the data structure, allowing terminals to request the type best suited to the user's context. This capability illustrates how the server's internal data structures and generative AI integration enable flexible and efficient reuse of computational results.
In each embodiment, the server, the terminal, and the user cooperate through the described technical means to realize a system that not only automates transcription and summarization tasks but also enhances the performance, scalability, and accuracy of the underlying computer technology through specialized data structures, neural network architectures, adaptive prompt sentence generation, and optimized communication mechanisms.

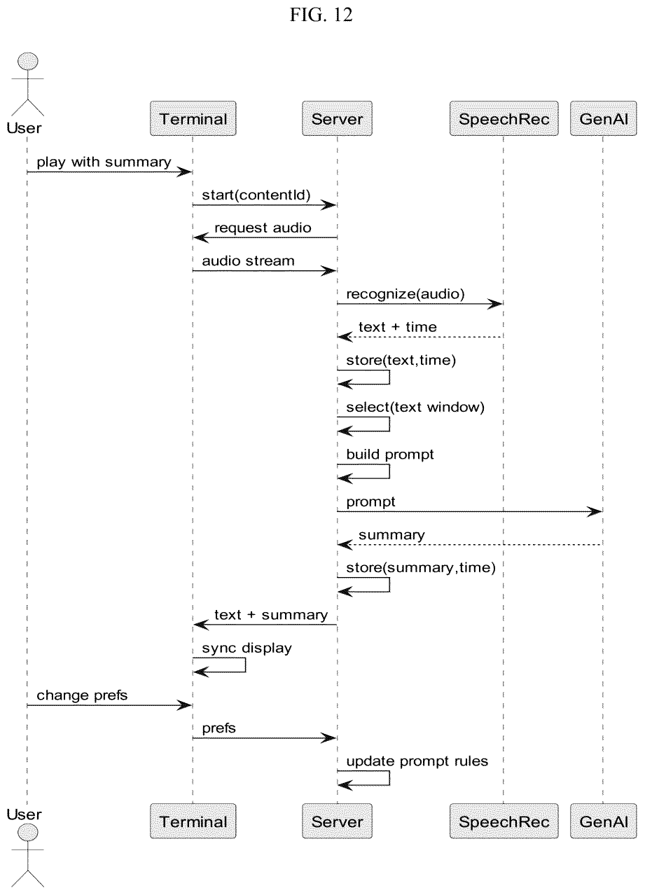

The following describes the processing flow using FIG. 12.
Step 1:
The user starts playback of audio information on the terminal. The user selects a content item (for example, a podcast episode or video clip) and activates a function such as “play with live captions and summary.”
Input: A user selection of content and a playback start command.
Output: A playback request message including a content identifier and a request flag for transcription and summarization, transmitted from the terminal to the server.
The terminal encodes this user action into a control message and sends it to the server via a network connection, thereby instructing the server to begin processing the corresponding audio information.
Step 2:
The server acquires the audio information corresponding to the user's playback request. The server either pulls an audio stream from a media source or receives audio frames directly from the terminal.
Input: The playback request message including the content identifier and processing request flag.
Output: A continuous audio stream segmented into audio frames stored in a server-side input buffer.
The server allocates memory buffers, opens a streaming session using a transport protocol, and writes incoming raw audio samples or compressed frames into a time-ordered queue, attaching initial timestamps to each frame.
Step 3:
The server converts the audio information into character information using a speech recognition technique.
Input: Buffered audio frames with associated timestamps.
Output: Character information segments (for example, words, phrases, or sentences) with recognition scores and time information.
The server pre-processes the audio by normalizing volume, applying a pre-emphasis filter, and segmenting the audio into fixed-length windows. The server then computes acoustic features such as log-mel spectrograms or MFCCs. The server feeds these feature vectors into a trained neural network acoustic model and decodes the output probabilities using a decoding algorithm (for example, beam search with a language model) to produce sequences of characters or tokens. The server associates each recognized segment with start and end timestamps derived from the audio frame positions.
Step 4:
The server stores and indexes the character information in a storage device together with time information.
Input: Character information segments with timestamps and recognition scores.
Output: A time-indexed transcript record stored in a database or other storage structure.
The server writes each segment into a data structure such as a table or document with fields including content identifier, segment identifier, start time, end time, text string, and confidence value. The server may merge adjacent segments that belong to the same sentence or split long segments based on punctuation. The server maintains indices on start time and end time to enable fast retrieval by playback position.
Step 5:
The server selects a subset of the stored character information as a summarization target based on current playback context.
Input: The time-indexed transcript record and the current playback position or time window.
Output: A text block consisting of one or more segments of character information selected for summarization.
The server determines a time window (for example, the most recent 60 seconds) relative to the playback position and queries the data structure for all segments whose timestamps fall within this window. The server concatenates the text of these segments into a coherent block, preserving the original order and inserting appropriate separators or punctuation.
Step 6:
The server generates a prompt sentence for a generative AI model using the selected character information and user preferences.
Input: The selected text block and user-specific conditions such as summarization length, target language, and explanation level.
Output: A prompt sentence that includes an instruction statement and the selected text block.
The server composes a natural-language instruction string based on stored or newly received user preferences. The server then attaches the text block after this instruction. Example prompt sentences include:
“Please summarize the following transcript in 3-4 concise sentences for a non-expert audience: [transcript text].”
“Translate and summarize the following English transcript into Japanese in 3-4 short sentences: [transcript text].”
“Explain the following transcript in simpler terms suitable for a beginner, using one concrete example: [transcript text].”
The server performs string concatenation, text encoding (for example, UTF-8), and optional truncation to meet context-length constraints of the generative AI model.
Step 7:
The server invokes the generative AI model to generate summarized character information from the prompt sentence.
Input: The encoded prompt sentence containing the instruction statement and the selected text block.
Output: Summarized character information (for example, a short paragraph or several sentences) generated by the generative AI model.
The server tokenizes the prompt sentence into model-specific tokens and sends them to the generative AI model. The model uses its transformer-based architecture to compute attention-weighted representations across tokens, applies feed-forward transformations, and predicts subsequent tokens using trained weights. During decoding, the server applies beam search or sampling with constraints such as maximum token count and temperature to generate a sequence of output tokens. The server converts the output tokens back into text, thereby obtaining a machine-generated summary or explanation of the original character information.
Step 8:
The server aligns and stores the summarized character information with time information derived from the original character information.
Input: Summarized character information and the time range of the underlying text block.
Output: A time-aligned summary record associated with the original transcript and playback interval.
The server determines a representative start time and end time for the summary, for example the minimum start time and maximum end time of all segments included in the summarized text. The server stores the summary in a separate summary table or collection, with fields for content identifier, summary identifier, start time, end time, summary text, and type (for example, concise summary or explanatory summary). This time alignment enables the server and terminals to associate each summary with a specific portion of the audio stream.
Step 9:
The server packages and transmits both character information and summarized character information to the terminal in real time.
Input: Newly created or updated transcript segments and summary records for the current playback window.

Output: Structured messages containing text segments, summaries, and time information sent over the network to the terminal.
The server serializes the data into a compact format, groups segments by time order, and may compress the data to reduce bandwidth. The server uses a push-capable protocol to send updates as soon as new segments or summaries become available. The server includes metadata fields such as language code, message type (caption or summary), and expiration or replay information so that the terminal can manage and display the data appropriately.
Step 10:
The terminal receives and buffers the character information and summarized character information from the server.
Input: Structured messages containing transcript segments, summaries, and time information.
Output: Local data buffers that store time-aligned captions and summaries for rendering.
The terminal parses incoming messages, checks integrity (for example, using sequence numbers or checksums), and inserts the segments into local lists or arrays indexed by time.
The terminal may discard outdated segments or overwrite earlier versions when updated text is received. By maintaining these buffers, the terminal prepares data for synchronized display with local audio playback.
Step 11:
The terminal renders captions and summaries on a display in synchronization with playback of the audio information.
Input: Local playback time, buffered character information, and buffered summarized character information.
Output: Visual representations of captions in a caption region and summaries in a summary region on the terminal display.
The terminal queries the local buffers for segments whose time intervals overlap the current playback time. The terminal then formats these segments as display lines, applying font rendering, line wrapping, and positioning on the screen. The terminal places short, time-critical text in the caption region near the audio or video area, and places the summarized text in a separate region, such as a collapsible panel or sidebar. The terminal updates these regions at regular intervals or upon playback time changes, ensuring that the displayed text tracks the spoken audio accurately.
Step 12:
The user optionally changes preferences that influence prompt sentence generation and summarization behavior.
Input: User operations on the terminal's user interface, such as selecting a target language, summary length, or explanation level.
Output: Control information messages sent from the terminal to the server describing updated summarization, explanation, translation, or expression conditions.
The terminal converts these user selections into structured control parameters and transmits them to the server. The server updates stored user profiles or session settings and uses these parameters when composing future prompt sentences. As a result, subsequent outputs from the generative AI model are adapted dynamically to the user's current needs without altering the underlying audio content or requiring manual rewriting of prompts.
Step 13:
The server generates and sends notification information to share text data with additional devices or users as needed.
Input: Selected character information and summarized character information along with sharing policies or subscription data.
Output: Notification messages containing at least part of the character information or summarized character information, transmitted to additional devices or user accounts.
The server identifies subscribers associated with the current content or session and formats concise notification messages, such as short summaries or key points, including identifiers that allow recipients to retrieve full context if desired. The server then sends these messages via notification channels or other communication services. This processing allows the system to reuse already computed summaries efficiently and reduces redundant processing for multiple consumers.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional computer-implemented meeting support systems typically record audio data and, in some cases, perform a simple speech-to-text conversion to obtain a transcript. However, such systems generally deliver long, unstructured text that is difficult for users to quickly comprehend, search, and share. As a result, users must manually read through large volumes of transcript data, manually identify decisions, tasks, and deadlines, and manually prepare human-readable summaries or reports. This manual post-processing introduces latency, inconsistency, and human error, and fails to leverage the full capabilities of modern information processing hardware and software.
Further, in many existing architectures, any summarization or analysis of text is either rule-based or applied uniformly, without dynamic adaptation to the length and content of the transcript, and without explicit, machine-generated prompt sentences that precisely instruct a generative AI model how to process the input. As a consequence, summaries generated by such systems may be incomplete, overly long, not focused on decision-critical content, or not suited to downstream computer processes such as indexing, searching, and automated notification workflows.
Moreover, conventional systems often provide only a static summary result without structuring the summary into machine-usable fields such as decision information, task item information, and deadline information, and without systematically generating and storing index information that ties together the original transcript, the structured summary, and associated identification information. This lack of structured representation decreases the efficiency of subsequent computer-implemented operations, such as retrieval by query, incremental updates, and automatic distribution to relevant endpoints.
Additionally, existing notification mechanisms in typical systems are frequently limited to generic messages that are not automatically derived from a structured meeting summary, and do not incorporate reference information that allows other computing devices to programmatically retrieve or display detailed content on demand. As a result, communication pathways between a server and information processing terminals remain under-optimized, and the computer network as a whole is not used in a manner that maximizes throughput, latency characteristics, and relevance of delivered content.
In the context of user-initiated summarization of arbitrary text, conventional tools typically require the user to manually construct prompts for a generative AI model, which demands specialized expertise and can lead to inconsistent or suboptimal outcomes. There is insufficient support at the system level for automatically generating prompt sentences that encode summarization range, summarization length, and expression style, and for aligning these parameters with the capabilities and constraints of the underlying generative AI model and computing resources.
Accordingly, there is a need for an improved computer-based system that (i) transforms raw audio into machine-usable character information, (ii) automatically divides and normalizes that information for efficient processing by a generative AI model, (iii) generates explicit, structured prompt sentences for the model, (iv) integrates the resulting summary information into a structured representation optimized for computer processing, indexing, and distribution, and (v) automatically generates and delivers notification messages containing outline and reference information to information processing terminals. Such a system should improve the functioning of the underlying computers and networks by reducing processing overhead, improving data organization, enabling more efficient retrieval and distribution, and enhancing the quality and consistency of content generated by the generative AI model.

The specific processing by the specific processing unit 290 of the data processing device 12 in Example 2 is realized by the following means.

The present invention provides a server comprising a processor and a memory storing instructions that, when executed by the processor, cause the processor to acquire audio information and convert the audio information into character information by using a speech recognition technique; to store the character information and identification information related to the audio information in a storage medium; to divide the character information into a plurality of character information groups according to an amount and content of the character information and normalize each of the character information groups into a format acceptable as input to a generative AI model that performs natural language processing; to generate, for each of the character information groups, a prompt sentence including an instruction sentence specifying a summarization target and a summarization style and including the corresponding character information group, and to input the prompt sentence into the generative AI model to cause the generative AI model to generate summary character information corresponding to each of the character information groups; to integrate the summary character information acquired from the generative AI model and structure the integrated summary character information as meeting summary information including decision information, task item information, and deadline information; to register the meeting summary information in an information management apparatus in association with the character information and the identification information and generate index information to be used for a search process or a reference process; to specify distribution destination information including shared-person information on the basis of the meeting summary information and generate a message in a notification format according to the distribution destination information; and to transmit the message to an information processing terminal via a communication network in real time and provide the meeting summary information so as to be viewable on the information processing terminal, and further cause the processor, in response to summarization request information input by a user together with character information, to generate the prompt sentence including an instruction sentence defining a summarization range, a summarization length, and an expression style and including the character information, to input the generated prompt sentence into the generative AI model to cause the generative AI model to generate summary character information according to the summarization request information, and to generate, as the message, notification information including outline information obtained by extracting a part of the meeting summary information and including reference information for accessing at least one of the meeting summary information and the character information. This enables an improvement in the functioning of the computer system and associated network by automatically transforming unstructured audio into structured, indexable, and distributable summary data, optimizing input to the generative AI model through explicit prompt sentences and content-aware segmentation, reducing manual intervention in summarization and distribution processes, enhancing retrieval and notification efficiency, and providing consistent, machine-usable representations of meeting-related information to information processing terminals in real time.

The term “audio information” refers to data representing sound, including but not limited to spoken utterances in analog or digital form, that is suitable for acquisition, recording, and processing by an information processing apparatus.
The term “character information” refers to data representing textual content encoded as characters or symbols in a machine-readable format, obtained for example by converting audio information into text by means of a speech recognition technique.
The term “speech recognition technique” refers to a computational procedure that analyzes audio information and outputs corresponding character information, typically using acoustic models, language models, and pattern recognition or machine learning algorithms.
The term “identification information” refers to data used to uniquely or distinctively associate audio information or character information with a particular session, event, user, time period, or other contextual attribute.
The term “storage medium” refers to a physical or virtual data-holding resource, such as a semiconductor memory, magnetic storage, optical storage, or network-accessible storage, capable of storing character information, identification information, and related data.
The term “character information group” refers to a subset of character information obtained by dividing larger character information into smaller units based on an amount or content of the character information, the subset being processed as an individual unit by subsequent functions.
The term “generative AI model” refers to a computational model, typically implemented as a trained machine learning model, that generates output data such as text in response to input data, and that is capable of performing natural language processing including summarization.
The term “natural language processing” refers to a class of computational techniques for analyzing, understanding, and generating human language content in a machine-readable form.
The term “normalize” refers to processing character information so as to conform to a predetermined format, structure, or constraint, including but not limited to tokenization, encoding conversion, length adjustment, or removal of unsupported elements, to enable the information to be input to a generative AI model.
The term “prompt sentence” refers to a text string or sequence that is provided as input to a generative AI model, the text string including at least one instruction sentence and at least a portion of character information, and specifying how the generative AI model should process the input.
The term “instruction sentence” refers to a part of a prompt sentence that explicitly describes operations, conditions, or constraints to be performed by a generative AI model, such as the summarization target, summarization style, summarization range, summarization length, or expression style.
The term “summary character information” refers to character information that has been generated by a generative AI model or other processing based on input character information, the summary character information representing a condensed or abstracted form of the original content.
The term “meeting summary information” refers to structured summary character information derived from character information corresponding to a meeting or discussion, and including at least decision information, task item information, and deadline information.
The term “decision information” refers to data within meeting summary information that represents conclusions, agreements, approvals, or resolutions reached during a meeting or discussion.
The term “task item information” refers to data within meeting summary information that represents work items, responsibilities, or actions to be performed, optionally including associated assignees or deadlines.
The term “deadline information” refers to data within meeting summary information that represents due dates, time limits, or time-related constraints associated with decision information or task item information.
The term “information management apparatus” refers to an information processing entity, which may include hardware and software, that stores, manages, and provides access to character information, meeting summary information, identification information, and related index information.
The term “index information” refers to data structures or records used to support search or reference processes, by associating keys such as terms, identifiers, or metadata with locations or identifiers of corresponding character information or meeting summary information.
The term “search process” refers to a computer-implemented operation in which index information is used to locate, retrieve, or filter character information, meeting summary information, or related data in response to a query.
The term “reference process” refers to a computer-implemented operation for accessing or displaying character information, meeting summary information, or related data based on index information or other association information, without necessarily performing a full text search.
The term “distribution destination information” refers to data specifying one or more recipients or endpoints, such as users, user groups, or information processing terminals, to which meeting summary information or related messages are to be delivered.
The term “shared-person information” refers to data that identifies persons or entities designated to receive or access meeting summary information, such as participants, stakeholders, or groups.
The term “notification format” refers to a structure or representation of a message suitable for delivery via a communication network, including, for example, push notification format, email format, or in-application message format.
The term “message” refers to data generated for transmission over a communication network to an information processing terminal, the data including at least part of meeting summary information, outline information, or reference information.
The term “communication network” refers to an interconnection of information processing devices that enables data transmission, including but not limited to wired or wireless networks, local area networks, and wide area networks.
The term “information processing terminal” refers to an end-user or client-side computing device, such as a mobile device, a personal computer, or another terminal apparatus, configured to receive, display, or otherwise process messages and meeting summary information.
The term “summarization request information” refers to data input by a user that specifies at least one requirement or preference for summarization, such as desired summarization range, summarization length, or expression style.
The term “expression style” refers to constraints or preferences on the wording or tone of generated summary character information, such as brevity level, technicality, formatting style, or target audience.
The term “summarization range” refers to a scope or portion of character information designated to be included in a summarization operation by a generative AI model or other summarization process.
The term “summarization length” refers to a quantitative constraint on the size of summary character information, such as a maximum number of characters, tokens, words, or sentences.
The term “outline information” refers to data representing a condensed or high-level portion of meeting summary information, such as key points, headlines, or highlights extracted from the full meeting summary information.
The term “reference information” refers to data that enables a computing device or user to access detailed information, such as identifiers, addresses, links, or metadata pointing to meeting summary information, character information, or associated records.
The term “notification information” refers to a type of message that includes at least outline information and reference information, and that is used to trigger or facilitate real-time notification to an information processing terminal.

In one embodiment, a server cooperates with one or more terminals and users to implement the claimed system. The server includes at least one processor, a main memory, a non-volatile storage device, and a network interface. The terminal includes a processor, a memory, an audio input device, a display, and a network interface. The user operates the terminal to capture audio information and to view and manage summary character information that is generated by the server.
The server uses general-purpose computing hardware such as a multi-core central processing unit and one or more graphics processing units. The server uses a storage subsystem such as a solid state drive managed by a file system. The server uses an operating system such as a generic server operating system, and middleware such as a web server framework (for example, a reverse proxy and a back-end HTTP application framework). The server further uses a database management system such as a relational database or a document-oriented database for storing character information, meeting summary information, and index information. The server optionally uses a search engine software for generating and using index information.
The terminal uses a mobile operating system or a desktop operating system, and provides an application that the user operates to start and stop audio capture, to send audio information to the server, and to display meeting summary information. The terminal uses an audio input application programming interface, such as a generic audio recording interface on a mobile operating system, that controls a built-in microphone and performs analog-to-digital conversion of the audio signal. The terminal encodes the audio signal using a codec provided by the operating system or a multimedia library. The terminal sends the encoded audio information to the server over a communication network using an HTTP client library.
The server receives the audio information through the network interface and web server software. The server stores the received audio information temporarily in a storage area. The server applies a speech recognition technique using a speech recognition engine that can be implemented as a local library or as a remote service. For example, the server can use a neural-network-based automatic speech recognition engine that internally uses an acoustic model, a pronunciation model, and a language model. The server converts the audio information into character information by passing the digital waveform to the acoustic model, computing spectral features such as Mel-frequency cepstral coefficients, and decoding the output of the model using a beam search algorithm over a vocabulary of subword units.
The server stores the generated character information in the database together with identification information such as a meeting identifier, a time range, and a participant identifier. The server represents the character information as a sequence of tokens, each token being a word or a subword encoded in a standard character set. The server may additionally store structural metadata such as sentence boundaries and speaker labels.
The server divides the character information into a plurality of character information groups according to at least one of a token count threshold and semantic boundaries such as topic shifts or agenda items. The server uses a tokenization module that counts tokens and splits the character information at suitable boundaries so that each character information group does not exceed a context window length that is supported by the generative AI model. The server normalizes each character information group by performing operations such as converting all characters to a target encoding, replacing unsupported characters, and inserting special delimiters that mark paragraph boundaries. By transforming the input into a normalized format, the server reduces errors and token overhead in the downstream generative AI model, thereby improving processing speed and generation stability.
The server uses a generative AI model implemented as a neural network architecture such as a transformer-based language model. In one embodiment, the generative AI model includes multiple attention layers, feed-forward layers, and embedding layers. The generative AI model is trained beforehand on a large corpus of text data using a self-supervised learning method such as next-token prediction. During training, the server (or a separate training system) uses an optimizer such as stochastic gradient descent with adaptive moment estimation, a loss function such as cross-entropy between predicted and target tokens, and a regularization method such as dropout. The server updates the model parameters by backpropagating gradients through all layers of the transformer and adjusting the weights to minimize the loss on the training corpus. The server can further fine-tune the generative AI model using domain-specific meeting transcripts and human-generated summaries, using supervised learning and a loss function that measures the difference between model-generated summaries and reference summaries.
The server generates a prompt sentence for each character information group. The server uses a prompt generation module that constructs a text sequence including an instruction portion and a content portion. The server inserts keywords describing a summarization target and a summarization style into the instruction portion, and appends the corresponding character information group. For example, the server may generate a prompt sentence of the form: “You are a meeting assistant. Summarize the following meeting transcript. Focus on key decisions, action items, responsible persons, and deadlines. Output in concise bullet points. Transcript: [character information group].”
The server may additionally generate a different prompt sentence when the user provides a specific summarization request. For example, the server may generate:
“Please summarize the following text: ‘AI technology is rapidly evolving and is being utilized in many industries. In particular, in the field of natural language processing, generative AI is attracting significant attention.’”
The server passes the prompt sentence to the generative AI model as input. The model processes the prompt sentence token by token and internally computes attention scores across tokens in each layer to capture relationships such as causal order, topic shifts, and emphasis on action verbs and date expressions. The model generates summary character information by autoregressively predicting the next token at each step, constrained by the semantics encoded in the instruction portion of the prompt sentence. Because the server explicitly structures the prompt sentence, the model can focus its computation on meeting-relevant aspects such as decision information, task item information, and deadline information, which improves summarization accuracy and reduces unnecessary token generation.
The server acquires the generated summary character information for each character information group, and integrates the multiple summary outputs into a unified meeting summary information data structure. The server uses a structuring module that parses each summary to extract decision information, task item information, and deadline information. The structuring module uses rule-based parsing and pattern matching, such as regular expressions and keyword-based classification, to identify phrases expressing decisions (“decided”, “approved”), tasks (“will do”, “must complete”), and deadlines (“by [date]”, “within [period]”). The server assigns these phrases to specific fields of a structured record, for example, a record having fields for a description, a responsible person, and a due date. The server thereby transforms unstructured summary character information into structured meeting summary information that is directly suitable for storage, indexing, and computation. The server registers the meeting summary information in an information management apparatus implemented as the database system. The server associates each item of meeting summary information with the underlying character information and the identification information so that a query can retrieve related data efficiently. The server generates index information by inserting index entries into a search engine or database index structure. For example, the server creates inverted index entries mapping key terms such as project names, person names, and dates to identifiers of the corresponding meeting summary information records. The server may also generate composite indexes over fields such as meeting date and responsible person. These indexes enable fast search operations and reduce the number of disk accesses and network calls required to retrieve relevant records, thereby improving the technical performance of the system.
The server specifies distribution destination information that includes shared-person information, such as participant identifiers or group identifiers. The server uses access control data and meeting metadata to determine which information processing terminals should receive notifications. The server generates a message in a notification format, for example a push notification format or an in-application message format, that includes outline information and reference information. The server may generate outline information by extracting the first few bullet points or sentences from the meeting summary information, and generate reference information as a uniform resource locator or identifier that the terminal can use to fetch the full meeting summary information from the server.
The server transmits the message over the communication network to the information processing terminal using a network protocol such as HTTPS. The server may use a push notification service as an intermediary delivery mechanism. The server structures the notification in a compact format to reduce payload size and network bandwidth consumption, thus lowering communication load and decreasing latency. When the terminal receives the notification, the terminal displays outline information immediately and, upon a user action, requests the full meeting summary information from the server using the reference information.
The server, by generating prompt sentences automatically on the basis of the character information and summarization request information, relieves the user from crafting complex prompts and enforces consistent model behavior across different summarization tasks. The server leverages the segmentation of character information into character information groups tailored to the generative AI model context length, thereby avoiding truncation errors and reducing repeated computation across overlapping segments. As a result, the server improves computational efficiency: the server processes only necessary tokens through the generative AI model and can parallelize processing of different character information groups across multiple processing units or different instances of the generative AI model.
The server also improves accuracy compared to a naive application of a generative AI model to a raw, very long transcript. The server constrains the summarization task via explicit instruction sentences and via a structured representation of meeting summary information, which causes the model to focus attention on relevant tokens and to generate summaries that align with the desired fields. Technical effects include a reduction of hallucinated content, improved recall of decision information and deadlines, and more consistent formatting suitable for downstream computational use, such as automatic calendar integration or task-tracking integration.
The server adopts training and inference strategies that differ from conventional human-centric summarization. For example, the server may fine-tune the generative AI model with additional supervised data where tokens corresponding to decisions and deadlines are given greater weight in the loss function, or the server may adjust sampling parameters such as temperature and top-k sampling thresholds to favor deterministic, concise outputs suited for machine processing. This use of weighted loss and specialized decoding strategies provides a non-conventional, computer-focused optimization that enhances repeatability and reduces noise in the generated summary character information.
In another embodiment, the server uses alternative neural network architectures or generative AI models, such as encoder-decoder models with attention, recurrent neural networks with gating mechanisms, or mixture-of-experts architectures. The server may select a particular architecture depending on available computing resources and required latency. The server may also infer summaries on specialized hardware such as tensor processing units or application-specific integrated circuits to reduce inference time and power consumption. In a further embodiment, the server may omit or simplify certain elements. For example, the server may perform fewer structuring operations when a simple narrative summary is sufficient. Alternatively, the server may incorporate additional modules, such as a speaker diarization module that separates speaker segments before summarization, or a topic segmentation module that groups character information by topic to further improve the relevance of the generated summary character information. The server may store additional metadata in the index information to allow more fine-grained search, such as filtering by topic or by action item status.
The terminal may vary in form. In one embodiment, the terminal is a mobile device that uses a built-in microphone and a mobile network connection. In another embodiment, the terminal is a desktop system with a dedicated microphone and a wired network interface. The terminal may run a native application or a web application. The terminal may also provide additional user interface elements for inputting summarization request information, such as sliders for summarization length, selection boxes for expression style, and checkboxes for specifying whether to include technical details or only high-level decisions.
The user uses the system in multiple scenarios. The user may initiate audio capture for a live meeting, and after the meeting, the user may receive a structured meeting summary information that is already indexed and shared with the relevant participants. The user may additionally use a text input interface to submit arbitrary reports or notes together with a summarization request, and the server generates a summary using a prompt sentence tailored to that request. For example, the user may input:
“Please summarize the attached report about the evolution of AI technology.”
The server then generates a prompt sentence that incorporates the user-requested constraints, passes the prompt sentence through the generative AI model, and returns a concise summary such as:
“AI technology is rapidly advancing across many industries, with generative AI becoming especially important in natural language processing.”
By implementing these interconnected hardware and software modules, the server, terminal, and user together achieve a system that is not a mere automation of human summarization, but rather an improvement in computer technology itself. The system reduces computational resources wasted on irrelevant content, structures data to support high-performance search and retrieval, and improves communication efficiency between server and terminal. The overall architecture, including segmentation of character information, generation of prompt sentences with explicit instruction sentences, use of a trained generative AI model with specialized training and decoding, and creation of structured meeting summary information and index information, yields technical effects such as faster processing, higher accuracy, reduced network load, and more reliable interaction between computing devices.

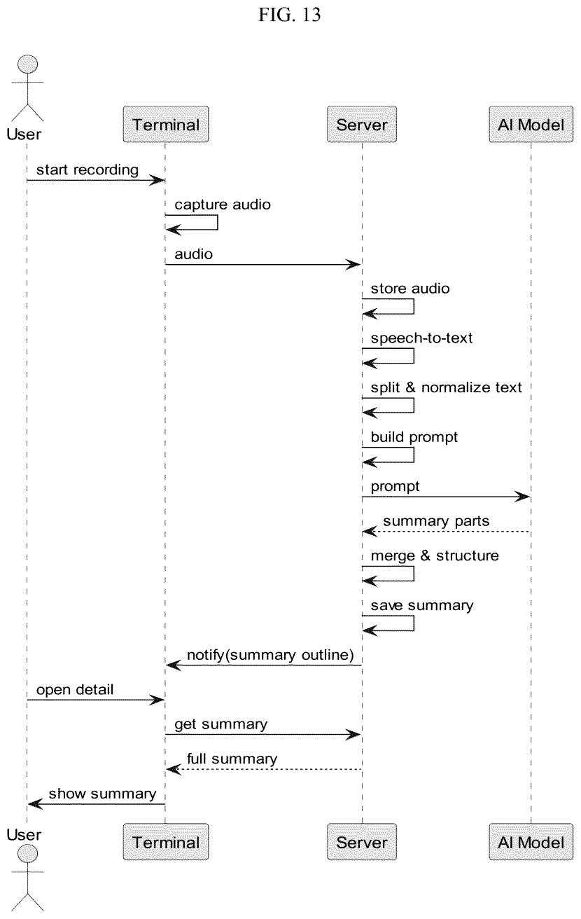

The following describes the processing flow using FIG. 13.
Step 1:
The user operates the terminal to start audio capture for a meeting or discussion.
The user launches an application on the terminal and selects a meeting recording function.
Input: A user operation (e.g., tapping a “Start Recording” button).
The terminal responds by activating an audio input interface provided by the operating system, controlling a built-in microphone, and starting analog-to-digital conversion of ambient sound into digital audio samples (for example, 16-bit PCM at a fixed sampling rate).
Output: A stream of digital audio data buffered in the memory of the terminal.
Step 2:
The terminal preprocesses the captured audio and prepares it for transmission to the server.
Input: The stream of digital audio data from Step 1.
The terminal applies encoding using a codec (for example, compressing PCM into a compressed audio format), segments the stream into fixed-duration chunks, and stores the chunks temporarily in local storage. The terminal may also attach metadata such as timestamps and a meeting identifier to each chunk.
Output: Encoded audio chunks with associated metadata stored locally on the terminal.
Step 3:
The terminal transmits the encoded audio chunks to the server over a communication network.
Input: The encoded audio chunks and metadata from Step 2.
The terminal opens an HTTPS connection to the server, constructs HTTP requests containing the encoded audio chunks and metadata in the request body, and sends the requests via the network interface. The terminal may send the chunks sequentially or in parallel depending on network conditions.
Output: HTTP requests containing audio data received by the server.
Step 4:
The server receives and stores the audio data for further processing.
Input: The HTTP requests containing encoded audio chunks and metadata from Step 3.
The server, using web server software, parses the HTTP headers and body, extracts the binary audio data and associated metadata, and writes the audio data to a storage medium in a structured directory or database record. The server records mapping information linking the meeting identifier and timestamps to corresponding audio files or segments.
Output: Persisted audio data records associated with identification information on the server.
Step 5:
The server converts the audio data into character information using a speech recognition technique.
Input: The stored encoded audio data and identification information from Step 4.
The server decodes the compressed audio into raw waveforms if necessary, and passes the waveforms to a speech recognition engine. The engine computes acoustic features (for example, spectrograms or Mel-frequency features), feeds them into an acoustic model, and decodes the output using a language model to obtain recognized tokens. The server combines the recognized tokens into text strings representing utterances, aligns them with timestamps, and concatenates them into a continuous transcript.
Output: Character information (transcript text) with associated timestamps and identification information.
Step 6:
The server stores the generated character information in an information management apparatus.
Input: The character information and identification information from Step 5.
The server creates database records containing the transcript text, meeting identifier, participant information (if available), and time ranges. The server inserts these records into a database table or document collection. The server may also store auxiliary structures such as sentence boundaries and speaker labels.
Output: Persistent character information records accessible via the database.
Step 7:
The server divides the character information into character information groups suitable for processing by a generative AI model.
Input: The full transcript text and metadata from Step 6.
The server tokenizes the transcript into units such as words or subwords, counts the tokens, and splits the transcript at appropriate boundaries so that each segment does not exceed a context window size supported by the generative AI model. The server may use sentence boundaries or topic markers as preferred split points. The server records the start and end indices of each segment relative to the original transcript.
Output: A plurality of character information groups, each representing a segment of the transcript with associated indices and metadata.
Step 8:
The server normalizes each character information group for input to the generative AI model.
Input: The character information groups from Step 7.
The server converts all text to a target encoding, removes or replaces unsupported control characters, standardizes punctuation, and inserts delimiters between logical sections if needed. The server may also perform token-level cleanup, such as merging broken tokens or normalizing whitespace. These operations reduce irregularities that would otherwise increase token count or cause misinterpretation by the generative AI model.
Output: Normalized character information groups ready for input to the generative AI model.
Step 9:
The server generates a prompt sentence for each normalized character information group.
Input: The normalized character information groups from Step 8 and configuration data specifying summarization style and target.
The server constructs a text string that includes an instruction sentence and the content to be summarized. The server concatenates fixed instruction phrases with dynamic parts such as meeting title and content. For example, the server may generate:
“You are a meeting assistant. Summarize the following meeting transcript. Focus on key decisions, action items, responsible persons, and deadlines. Output in concise bullet points. Transcript: [normalized character information group].”
By embedding the segment into this template, the server expresses constraints and priorities to the generative AI model.
Output: A corresponding prompt sentence for each normalized character information group.
Step 10:
The server inputs each prompt sentence into the generative AI model and obtains summary character information.
Input: The prompt sentences from Step 9.
The server sends each prompt sentence to the generative AI model via an API call or an internal inference module. Inside the model, the text is tokenized, embedded, and processed through multiple attention and feed-forward layers. The model computes probability distributions over possible next tokens conditioned on the prompt and previously generated tokens, and selects tokens according to decoding rules such as greedy decoding or constrained sampling. The server collects the output tokens and reconstructs them into a text string representing a summary for that character information group.
Output: Summary character information segments corresponding to each character information group.
Step 11:
The server integrates the multiple summary segments into unified meeting summary information.
Input: The summary character information segments from Step 10 and segment metadata. The server concatenates or merges the summary segments in the logical order of the original transcript. The server applies a structuring algorithm that scans the merged summary text for patterns indicating decisions, tasks, and deadlines. Using rules and pattern matching (for example, detecting phrases like “decided to”, “will complete by”, or explicit dates), the server extracts these elements and inserts them into a structured data model with fields for decision information, task item information, and deadline information.
Output: Structured meeting summary information that includes both free-text summary and field-specific data.
Step 12:
The server registers the meeting summary information and generates index information.
Input: The structured meeting summary information from Step 11 and original character information references.
The server stores the structured meeting summary in the database, linking it to the transcript record via identifiers. The server generates index entries that map keywords (for example, project names, person names, date values) and field values to record identifiers. The server inserts these entries into an index data structure, such as an inverted index or a composite database index. This data processing enables fast retrieval, because search queries need only access the index instead of scanning full text.
Output: Persisted meeting summary records and index information for search and reference processes.
Step 13:
The server determines distribution destination information based on the meeting summary information.
Input: The meeting summary information and participant or role metadata from Step 12.
The server reads configuration data specifying which users or groups should receive summaries for particular meetings or topics. The server matches participants listed in the summary with user accounts and associated terminals. By performing database lookups and rule evaluation, the server compiles distribution destination information including shared-person information and device identifiers.
Output: A set of distribution destination records specifying recipients and preferred notification channels.
Step 14:
The server generates a message including outline information and reference information.
Input: The meeting summary information from Step 12 and the distribution destination information from Step 13.
The server selects key portions of the meeting summary, such as the first few bullet points or sentences emphasizing decisions and deadlines, to form outline information. The server generates reference information such as a unique link, an identifier, or a short code that the terminal can use to request full details. The server constructs a message payload in a notification format, embedding outline information and reference information into the body or metadata fields according to the requirements of the notification channel.
Output: Notification messages each containing outline information and reference information.
Step 15:
The server transmits the messages to the terminals via the communication network.
Input: The notification messages from Step 14 and the distribution destination records.
The server connects to notification or messaging services and sends each message to the corresponding terminal endpoint, for example using push notification protocols or in-application messaging protocols over HTTPS. The server may batch messages to reduce network overhead, and may include priority flags to request timely delivery.
Output: Messages delivered to the terminals and queued or displayed by the terminal operating systems.
Step 16:
The terminal receives and presents notification information to the user.
Input: The messages transmitted by the server in Step 15.
The terminal's operating system receives the push or in-app notification, extracts the outline information and reference information from the payload, and displays a notification banner or dialog. The terminal shows a brief description of key decisions or tasks so that the user can quickly judge relevance without downloading the full summary.
Output: A user-visible notification containing an outline of the meeting summary and a control (such as a button) linked to the reference information.
Step 17:
The user interacts with the notification to view full meeting summary information.
Input: The notification and its controls from Step 16.
The user selects the notification, for example by tapping it on a touch screen. The terminal interprets this action as a request to access the full meeting summary information and issues an HTTPS request to the server using the reference information included in the notification.
Output: A request from the terminal to the server specifying the referenced meeting summary information.
Step 18:
The Server Returns the Full Meeting Summary Information and Optional Transcript to the terminal.
Input: The request containing reference information from Step 17.
The server uses the reference information as a key to retrieve the corresponding meeting summary record and, if requested, the underlying transcript from the database. The server formats this data as a response payload structured in a machine-readable format and sends it back to the terminal via HTTPS.
Output: A response containing full meeting summary information and, optionally, associated character information.
Step 19:
The terminal displays the meeting summary information and optional transcript to the user.
Input: The response data from Step 18.
The terminal parses the response, renders the structured meeting summary in a user interface with clear sections for decision information, task item information, and deadline information, and optionally provides a view of the full transcript. The terminal enables the user to scroll, search within the summary, and perform actions such as copying text or sharing the summary through other applications.
Output: A human-readable presentation of the meeting summary information and any associated transcript for the user.
Step 20:
The user initiates a text-based summarization request for arbitrary content.
Input: User-entered text and summarization preferences.
The user opens a summarization screen on the terminal, pastes or types text (for example, a report), and specifies desired constraints such as “short summary” or “technical tone.” The terminal packages this text together with summarization request information and sends it to the server via HTTPS.
Output: A summarization request containing raw text and summarization request information received by the server.
Step 21:
The server generates a prompt sentence based on the user's request and the provided character information.
Input: The user-provided text and summarization request information from Step 20.
The server reads parameters such as summarization range, summarization length, and expression style, and constructs a prompt sentence that encodes these constraints. For example, the server may generate:
“Please summarize the following text in three concise sentences, using plain language suitable for non-experts: [user-provided text].”
The server thereby transforms abstract user preferences into a concrete generative AI model instruction.
Output: A prompt sentence tailored to the user's summarization request.
Step 22:
The server processes the user-specific prompt sentence with the generative AI model and returns a custom summary.
Input: The prompt sentence from Step 21.
The server sends the prompt sentence to the generative AI model, which performs token-level inference and generates a summary according to the specified constraints. The server collects the generated tokens, reconstructs them into summary character information, and verifies that length and style requirements are satisfied, optionally truncating or post-processing if necessary. The server then returns the summary to the terminal via an HTTPS response.
Output: Customized summary character information delivered to the terminal for display to the user.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional computer systems that generate summaries or meeting minutes from audio streams typically perform a linear pipeline in which speech recognition is executed, a large block of resulting text is passed to a generic generative AI model, and the output is simply displayed or stored. Such systems suffer from several technical problems.
First, the systems handle large, unstructured text sequences without context selection, which increases processing latency, network bandwidth consumption, and memory footprint in the generative AI model, and often leads to loss of important information or hallucinated content. Second, the systems do not systematically incorporate emotion analysis results into the input of the generative AI model, so the generated summaries or meeting records lack structured emotional context and cannot accurately reflect the atmosphere or sentiment dynamics of the underlying conversation. Third, the systems typically present summary information and emotion information in separate user interfaces or logs, forcing the user terminal to perform application-level correlation and display, which results in redundant processing, complex client logic, and inconsistent user interfaces across devices. Fourth, the systems do not control, at the server level, the generation of prompt sentences that include both content-based context and emotion-based context, and therefore cannot optimize prompt construction for the constraints of the generative AI model or ensure stable, predictable outputs.
As a result, computer resources in the server and in the user terminal are not used efficiently, processing throughput for multi-user, multi-meeting scenarios is limited, and the overall reliability and utility of AI-assisted summarization and reporting functions are degraded. There is therefore a need for a computer-implemented technique that, within the server, tightly integrates speech recognition, structured text storage, emotion analysis, dynamic prompt sentence generation, generative AI model invocation, and unified display-oriented formatting, in order to improve the technical operation of the system as a whole.

The specific processing by the specific processing unit 290 of the data processing device 12 in Application Example 2 is realized by the following means.

The present invention provides a server comprising a processor and a storage device, the processor being configured to acquire audio information, convert the audio information into character information by executing a speech recognition process, store the character information in the storage device, execute an emotion analysis process on the character information to extract emotion information, generate a prompt sentence that embeds context information including a portion of the character information selected according to an importance degree and an outline of the emotion information so as to instruct a generative information processing model to generate summary information or meeting record information reflecting the emotion information, input the prompt sentence and the character information into the generative information processing model to cause the generative information processing model to generate the summary information or the meeting record information, generate display data in which an emotion index corresponding to the emotion information is added to each part of the summary information or the meeting record information, and transmit the display data and notification information regarding the summary information or the meeting record information to a user terminal and to an information sharing device having a communication function via a network. This enables improvement of computer technology by reducing the computational and memory load on the generative information processing model through server-side context selection, by integrating emotion analysis results directly into the prompt sentence so that the generated output structurally reflects emotional states, by off-loading formatting and correlation of summary information and emotion indices to the server so that user terminals can perform simpler rendering operations, and by increasing overall processing throughput and responsiveness of multi-user, networked summarization and reporting services.

The term “audio information” refers to information representing sound, including spoken utterances, that is acquired from an audio input device as analog signals and converted into digital data suitable for processing by a computer system.
The term “character information” refers to information representing text that has been obtained by converting audio information into a sequence of characters or symbols using a speech recognition process, and that can be stored, analyzed, and processed by a computer system.
The term “speech recognition process” refers to a computational process in which a computer system analyzes audio information, detects acoustic features, and converts the detected features into character information using an acoustic model and a language model.
The term “storage device” refers to a hardware or virtual component, such as a memory device, a magnetic or optical recording medium, or a network-based storage service, that is configured to store character information, emotion information, prompt sentences, and generated output information in a non-transitory manner.
The term “emotion analysis process” refers to a computational process in which a computer system analyzes character information or audio information to identify one or more emotional states, such as joy, anger, sadness, or confidence, and outputs the result as structured data.
The term “emotion information” refers to information that indicates an estimated emotional state associated with part or all of character information or audio information, including emotion categories, scores, intensity values, or other indices that express emotional characteristics.
The term “generative information processing model” refers to a machine-implemented model, such as a generative AI model, that receives a prompt sentence and optionally additional input data, and that generates new character information, such as summary information or meeting record information, based on learned statistical relationships.
The term “prompt sentence” refers to character information that is constructed to provide instructions and context to a generative information processing model, and that may include a description of a desired output, a portion of character information selected according to an importance degree, and an outline of emotion information.
The term “summary information” refers to character information that condenses original character information by extracting and rephrasing important elements while omitting less important details, thereby providing a shorter representation of the content.
The term “meeting record information” refers to structured character information that represents the content of a discussion or meeting, and that may include items such as agenda, discussion points, decisions, action items, and timestamps.
The term “importance degree” refers to a measure used by a computer system to evaluate the relative importance of parts of character information, based on criteria such as frequency of terms, position in the discourse, presence of keywords, or correlation with detected emotions.
The term “context information” refers to information that is provided to a generative information processing model together with instructions, and that includes at least a portion of character information and an outline of emotion information, thereby enabling the model to generate output that reflects both content and emotional aspects.
The term “display data” refers to data generated by a computer system for presentation on a display device, including layout information, summary information or meeting record information, and an emotion index associated with parts of the summary information or the meeting record information.
The term “emotion index” refers to a value, symbol, label, or set of values indicating an emotional state associated with a part of summary information or meeting record information, and that is suitable for visual representation on a user terminal.
The term “display device” refers to a device or component, such as a monitor, a touch screen, or a head-mounted display, that is configured to present display data to a user in a human-perceptible form.
The term “user terminal” refers to an information processing device operated by a user, such as a personal computer, a tablet, a smartphone, or a wearable device, that is configured to communicate with a server, receive display data and notifications, and present information to the user.
The term “information sharing device” refers to an information processing device or service that has a communication function and that is configured to receive and distribute character information, summary information, meeting record information, or emotion information to multiple users or systems.
The term “communication function” refers to a capability of an information processing device or service to send and receive information via a wired or wireless communication network using one or more communication protocols.
The term “notification information” refers to information transmitted by a computer system to a user terminal or an information sharing device to indicate that new or updated summary information or meeting record information is available, and that may include identifiers, timestamps, and brief descriptions of the updated content.

In one embodiment, a server, a terminal, and a user cooperate to implement the claimed system. The server includes at least one processor, a main memory, a non-transitory storage device, and a network interface. The terminal includes a processor, a microphone, a display device, an input device, and a communication interface. The user operates the terminal to provide audio information and to receive generated summary information and meeting record information.
The terminal uses a hardware microphone, such as a built-in microphone of a smartphone or a headset microphone connected to a personal computer, to capture audio information representing the user's speech or a conversation among multiple participants. The terminal converts the analog audio signals into digital audio data using an audio codec implemented in a device driver and an operating system of the terminal. The terminal buffers the digital audio data in main memory and transmits the digital audio data to the server through a wired or wireless network using a protocol such as Hypertext Transfer Protocol Secure over Transmission Control Protocol/Internet Protocol.
The server uses a speech recognition component implemented in software to convert the received audio information into character information. The server, for example, uses a speech recognition application programming interface provided by a cloud-based speech recognition service, such as a generic cloud speech-to-text service, which applies an acoustic model and a language model to the input audio frames. The server encodes the digital audio data into a format accepted by the speech recognition service, such as linear pulse-code modulation or a compressed format, and sends the encoded data together with parameters, such as sampling rate and language code, to the speech recognition service. The server receives a recognition result as structured data, parses the structured data, and obtains a sequence of characters that constitute character information corresponding to the audio information.
The server stores the character information in a storage device as records in a database. The server uses a relational database management system or a document-oriented database to store, for each segment of character information, a meeting identifier, a segment identifier, a start time and an end time, and a speaker identifier if available. The server stores the character information in association with this metadata as fields in a table or as elements of a structured document. This specific data structure allows the server to select parts of the character information according to time, speaker, or topic without loading an entire transcript into memory.
The server applies an emotion analysis process to the character information to derive emotion information. In one example, the server uses an emotion analysis engine implemented as a neural network model trained for text-based emotion classification. The server may use an external emotion analysis service or an in-house model implemented using a machine learning framework. The server converts each segment of character information into a sequence of tokens and then into numerical vectors using a word embedding or sub-word embedding technique. The server inputs these vectors to a neural network, such as a bidirectional recurrent neural network, a convolutional neural network, or a transformer-based encoder. The neural network outputs a probability distribution over a plurality of emotion categories, such as joy, anger, sadness, surprise, and neutrality. The server interprets the probability distribution and selects one or more emotion categories and associated scores as emotion information. The server stores the emotion information as fields in the same database, linked to the corresponding character information via the segment identifier. By storing emotion information in this structured manner, the server reduces repeated computation for later queries and enables efficient retrieval of emotion patterns using indexed queries.
In another embodiment, the server applies an emotion analysis process directly to the audio information. The server uses acoustic features, such as pitch, energy, and spectral features, extracted from the audio frames as input to an acoustic emotion classifier. The classifier may be implemented as a feedforward neural network, a recurrent neural network, or a transformer-based model trained on labeled emotional speech data. The server combines the audio-based emotion information and the text-based emotion information, for example by weighted averaging of scores or by rule-based selection, to improve robustness of emotion detection.
The server constructs a prompt sentence to instruct a generative AI model, which is a generative information processing model, to generate summary information or meeting record information. The server selects a subset of the stored character information according to an importance degree. The server computes the importance degree for each segment based on a combination of factors, such as frequency of domain-specific terms, presence of key phrases, position in the meeting timeline, and magnitude of associated emotion scores. The server may compute a numerical score for each segment using a weighted sum or a machine-learned scoring function and then sort segments according to the numerical score. The server selects top-ranked segments within a token budget corresponding to a context length limit of the generative AI model. This server-side selection reduces the size of data that must be transmitted to and processed by the generative AI model, thereby reducing computation time and memory usage in the generative AI model.
The server generates context information to be embedded in the prompt sentence. The server concatenates the selected segments of character information into a context text and generates an outline of emotion information, for example by computing statistics such as counts or average scores of each emotion category per time interval or per topic. The server converts the emotion statistics into human-readable sentences or a structured textual summary, such as “During the discussion on budget, concern and frustration scores increased significantly.”
The server then constructs a prompt sentence by combining instructions and the context information. Examples of prompt sentences include:
“Please summarize the following meeting transcript in English. Focus on key decisions and action items: “{transcript text}””
“Please create formal meeting minutes based on the following transcript and reflect the emotions of the speakers (joy, anger, sadness, etc.) in each agenda item. Transcript: “{transcript text}”. Emotion data: “{emotion summary}””
“Please summarize the following text and generate concise minutes with agenda, discussion, decisions, and action items: “{recognized text}””
“Please summarize the following meeting segment and, if possible, comment briefly on the overall emotional tone: “{recent transcript}””
The server inputs the prompt sentence and the corresponding character information into the generative AI model. In one embodiment, the generative AI model is implemented as a transformer-based neural network with multiple attention layers, trained on a large corpus of text and fine-tuned for summarization. The server encodes the prompt sentence and the character information into tokens according to a tokenizer of the model, transmits the tokens to a model execution service, and receives generated tokens as output. During training, the generative AI model has been optimized by minimizing a loss function, such as cross-entropy between predicted tokens and reference tokens, using gradient-based optimization. The model parameters, including weights in attention layers and feedforward layers, have been updated iteratively using training data that includes pairs of input texts and target summaries or meeting records. The server uses the trained model in an inference mode without further updating weights, and the server may control generation behavior using parameters such as temperature, top-k or top-p sampling thresholds, and maximum output length.
The generative AI model processes the prompt sentence using attention mechanisms that relate different parts of the context and the instruction. By embedding emotion summaries and segment-level emotion information into the prompt, the server causes the generative AI model to attend not only to lexical importance but also to emotional importance. This non-conventional prompting strategy leads the model to produce output that highlights emotionally salient events, such as disagreements or enthusiasm, in a systematic way not achievable by simple keyword-based extraction. Because the server controls which segments and which emotion statistics are included, the server can adapt the prompt to meet constraints of the computing environment, such as limited memory on a model accelerator, and can reduce redundant or low-value content, thereby improving processing efficiency.
The server receives generated summary information or meeting record information as character information. The server stores the generated information in the storage device as a separate record linked to the original transcript and emotion data. The server then generates display data by associating emotion information with each part of the generated summary information or meeting record information. For example, the server maps sentence-level emotion scores from original segments to the corresponding sections of the generated output by using alignment techniques, such as approximate string matching or segment-level identifiers. The server generates a data structure that includes, for each sentence or bullet point in the summary information, an emotion index indicating a dominant emotion and its intensity. The server encodes the display data in a format suitable for rendering, such as a structured markup describing text and associated emotion labels.
The server transmits the display data and notification information to the terminal through the network. The terminal receives the display data and renders the summary information or meeting record information on the display device, such as a liquid crystal display or an organic light-emitting diode display. The terminal visually distinguishes emotional states, for example by coloring text segments, attaching icons, or displaying bar graphs next to sentences. Because the server has already generated the display data with emotion indices, the terminal performs mainly rendering functions and does not need to execute complex emotion analysis or correlation logic, thereby reducing processing load on resource-limited devices such as wearable devices and smartphones.
The server also transmits the summary information or meeting record information and the emotion information to an information sharing device having a communication function, such as a collaboration service or a messaging service. The server submits messages through an application programming interface of the collaboration service, including the generated information and optionally links to full transcripts stored in the database. The information sharing device distributes the messages to multiple user terminals, which receive notifications about new content. This distribution allows multiple users to access an integrated view of content and emotion without having each terminal independently perform summarization or emotion analysis.
This configuration produces a technical effect that extends beyond mere automation of human summarization work. The server reduces the amount of data transmitted to the generative AI model by selecting segments according to an algorithmic importance degree and by embedding a compact emotion summary into the prompt sentence. Consequently, memory usage in the model execution environment is reduced, and generation time is shortened, particularly when many meetings and users are processed concurrently. The structured storage of character information and emotion information enables index-based retrieval and efficient aggregation, which improves data management and reduces query latency. The server-side generation of display data reduces redundant processing on terminals and avoids duplicate implementations of correlation logic, which simplifies client software and reduces communication overhead, because emotion indices are compressed into symbols rather than transmitting raw emotion analysis results for every utterance.
In another embodiment, the generative AI model and the emotion analysis engine are partially integrated. The server may implement a dual-head transformer architecture, where a shared encoder processes the selected character information and a first decoder head generates summaries while a second classifier head outputs emotion distributions. During training, the server uses a multi-task loss function that combines a summarization loss and an emotion classification loss. The server trains the model using stochastic gradient descent or a similar optimization method, updating parameters to minimize the combined loss. In such an embodiment, the server can reduce the number of separate calls to external services, thereby reducing network latency and avoiding serialization of outputs between independent components.
In yet another embodiment, the server adjusts the importance degree calculation according to system load. When the server detects high load, the server increases thresholds for segment selection and compresses the context text more aggressively, thereby keeping the prompt size within a limit that allows the generative AI model to maintain a constant response time. When load is low, the server may allow more segments to be included, increasing summarization detail. Thus, the server dynamically controls computational complexity at the prompt level, which is a non-conventional technique to manage resource consumption in a generative AI environment.
The user may use the system in various concrete scenarios. In one example, the user conducts a regular project meeting, and the terminal records audio during the entire meeting. The server converts the audio to character information, executes emotion analysis, and generates a prompt sentence with a context instructing the generative AI model to produce action-oriented minutes. The generative AI model responds to a prompt sentence such as: “Please create formal meeting minutes based on the following transcript and reflect the emotions of the speakers (joy, anger, sadness, etc.) in each agenda item. Transcript:
“{transcript text}”. Emotion data: “{emotion summary}””
The server then provides the user with minutes that explicitly indicate where frustration about schedule delays occurred, and the server shares this information with collaborators. In another example, the user requests a quick executive summary while the meeting is ongoing, and the server constructs a shorter prompt sentence such as:
“Please summarize the following meeting transcript in English. Focus on key decisions and action items: “{transcript text}””
The generative AI model returns a short list of decisions, and the server overlays emotion indices on each item to indicate confidence or concern levels.
Alternative implementations may vary individual modules while preserving the overall structure. The speech recognition process may be implemented entirely on the server using a local model instead of a cloud-based service. The emotion analysis process may use rule-based features, such as lexicons of emotional terms and syntactic patterns, in addition to or instead of neural network models. The generative AI model may be replaced with a smaller model hosted on the server, a model executed on specialized hardware accelerators, or a model that uses different decoding strategies such as beam search with coverage penalties to avoid omission of important points. The prompt sentence content and structure may be adapted to different domains, such as medical conferences or educational sessions, by adjusting instruction wording and importance degree criteria.
Because the server organizes data structures, processing order, and model invocations in a specific way, the system improves technical performance of the computer environment. The combination of: (i) structured storage of character information and emotion information, (ii) algorithmic selection of high-importance segments, (iii) construction of prompt sentences embedding both content and emotion context, and (iv) server-side generation of display data with emotion indices, causes reduction in memory usage and processing time for generative AI operations, reduction in communication load between server and terminals, and increase in accuracy and relevance of generated summaries and meeting records. These technical improvements arise from the specific way in which the server processes and structures data and interacts with the generative AI model, rather than from a mere automation of human cognition.

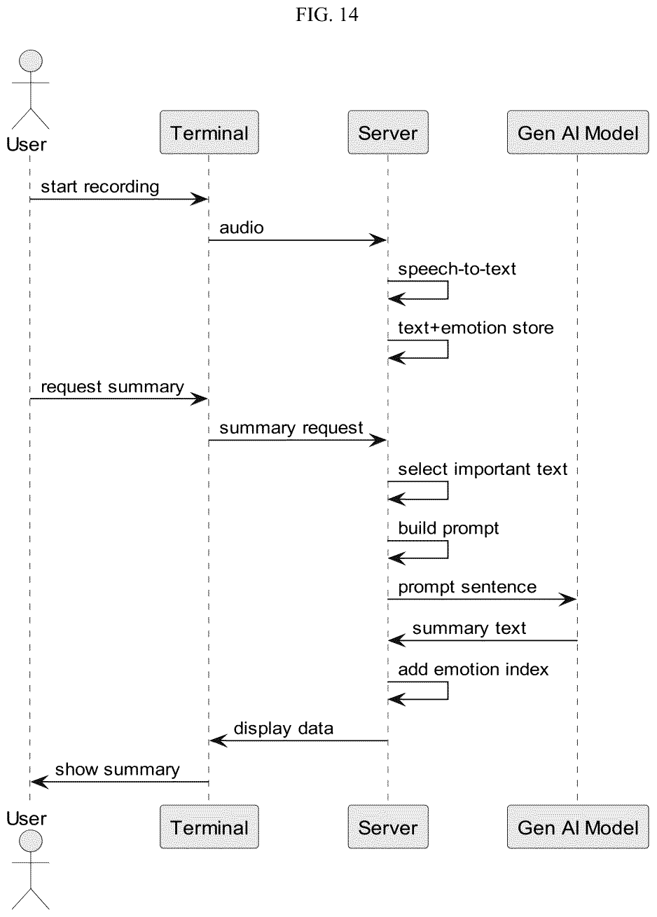

The following describes the processing flow using FIG. 14.
Step 1:
The user initiates recording on the terminal.
The user presses a recording start button on the terminal's user interface.
The input is a user operation event, and the output is a control signal that instructs the terminal to activate its audio capture module.
The terminal receives the control signal, initializes an audio buffer in memory, configures the sampling rate and bit depth in an audio driver, and prepares to acquire audio information from a microphone.
Step 2:
The terminal acquires audio information and transmits it to the server.
The terminal uses a microphone to capture analog sound waves and converts them into digital audio frames using an analog-to-digital converter and an audio codec.
The input is analog audio from the environment, and the output is a stream of digital audio frames (for example, 16-bit PCM frames at 16 kHz).
The terminal groups the audio frames into chunks, appends metadata such as a meeting identifier and timestamps, and sends each chunk to the server via a secure network connection, for example using HTTPS or a WebSocket connection.
Step 3:
The server receives audio information and prepares it for speech recognition.
The server accepts incoming network packets, reconstructs the original audio chunks, and verifies integrity using checksums or protocol headers.
The input is a sequence of audio chunks with metadata, and the output is a normalized audio stream stored in a temporary buffer or a file.
The server converts the audio into a format required by a speech recognition component, such as converting to a specific sampling rate, channel configuration, or encoding, and records corresponding metadata in an internal data structure.
Step 4:
The server converts audio information into character information using a speech recognition process.
The server submits the normalized audio data and language parameters to a speech recognition engine, either locally or through a remote speech recognition service.
The input is the normalized audio stream, and the output is character information representing a recognized transcript.
The server receives recognition results as structured data, parses recognized tokens and confidence scores, concatenates partial transcripts into ordered segments, and produces character information segments each associated with a time range and a meeting identifier.
Step 5:
The server stores character information in a storage device.
The server constructs database records that include the meeting identifier, segment identifier, timestamps, speaker information if available, and the text content for each segment.
The input is a set of character information segments with metadata, and the output is one or more stored records in a database table or document collection.
The server executes insert operations through a database interface, assigns indexes for fast retrieval, and commits the transaction so that the character information is persistently stored.
Step 6:
The server executes an emotion analysis process on character information to extract emotion information.
The server retrieves newly stored character information segments from the database or from an in-memory buffer and converts each segment into a feature representation suitable for an emotion classifier, such as token embeddings or word vectors.
The input is a character information segment, and the output is emotion information indicating one or more emotion categories and associated scores.
The server feeds the feature representation into an emotion analysis model, computes a probability distribution over emotion labels, selects one or more dominant emotions based on a threshold or maximum probability, and formats the result as emotion information associated with the segment.
Step 7:
The server stores emotion information in association with character information.
The server prepares database records that link each emotion output to its corresponding character information segment using a segment identifier.
The input is emotion information and the identifier of the related segment, and the output is a set of stored emotion records in the storage device.
The server writes these records into an emotion table or adds emotion fields to existing transcript records, and updates indexes so that records can be retrieved efficiently by meeting, time range, or emotion type.
Step 8:
The user requests generation of summary information or meeting record information.
The user selects a meeting session on the terminal and chooses an operation such as “Generate Summary” or “Generate Minutes.”
The input is a user request including a meeting identifier and a desired output type, and the output is a request message sent to the server.
The terminal formats the request as a structured message, attaches the user identifier and requested mode (for example, summary or detailed minutes), and transmits the request to the server over the network.
Step 9:
The server selects character information segments according to an importance degree.
The server retrieves all character information segments and associated emotion information for the requested meeting from the storage device.
The input is a collection of segments with text content and emotion scores, and the output is a ranked list of segments with importance scores.
The server computes an importance degree for each segment by applying a scoring function that may combine factors such as term frequency, presence of key phrases, segment position, and the magnitude of emotion scores; the server then sorts segments by their importance degree and selects a subset that fits within a token limit for the generative AI model.
Step 10:
The server generates context information from selected segments and emotion information.
The server concatenates the selected segments into a context text and aggregates emotion information into summaries, such as per-topic or per-time-interval statistics.
The input is the ranked subset of segments and their emotion information, and the output is a context text and an emotion summary text.
The server computes aggregated values, such as average emotion scores or counts of high-emotion segments, converts these aggregates into textual descriptions, and combines them with the context text in a structured order suitable for a prompt.
Step 11:
The server constructs a prompt sentence for a generative AI model.
The server embeds instructions, the context text, and the emotion summary into a single prompt sentence or into a set of prompt sentences according to a predefined template.
The input is a context text, an emotion summary, and a specification of the desired output (summary or minutes), and the output is a prompt sentence that conforms to the input format of the generative AI model.
The server generates text such as “Please create formal meeting minutes based on the following transcript and reflect the emotions of the speakers (joy, anger, sadness, etc.) in each agenda item. Transcript: “{transcript text}”. Emotion data: “{emotion summary}”” and checks that the resulting prompt fits within the token constraints.
Step 12:
The server transmits the prompt sentence and character information to the generative AI model and receives generated output.
The server encodes the prompt sentence and, if required, parts of the character information into tokens using a tokenizer associated with the generative AI model and sends the tokens to a model execution service.
The input is the prompt sentence and optional additional character information, and the output is generated character information representing summary information or meeting record information.
The server receives a sequence of generated tokens from the model execution service, converts the tokens back into text, and obtains a complete generated output string.
Step 13:
The server post-processes the generated summary information or meeting record information.
The server analyzes the generated text to ensure that basic structural elements such as headings, bullet points, and sections are present according to the requested format.
The input is the raw generated text from the generative AI model, and the output is a normalized and structured text suitable for storage and display.
The server splits the text into sections, corrects formatting issues such as duplicated headings or trailing punctuation, and may insert standard labels such as “Agenda,” “Decisions,” and “Action Items” if they are missing.
Step 14:
The server aligns emotion information with parts of the generated output and generates display data.
The server maps original character information segments and their emotion information to corresponding portions of the generated output, for example by string matching or by using identifiers embedded in the prompt.
The input is the structured generated text and the emotion information associated with original segments, and the output is display data that pairs each part of the generated text with an emotion index.
The server computes, for each sentence or bullet in the generated text, a representative emotion index based on the linked segments, and constructs a data structure containing text units and associated emotion indices ready for rendering.
Step 15:
The server stores the generated output and display data in the storage device.
The server creates records for the generated summary information or meeting record information and associates them with the underlying meeting identifier and with the corresponding display data structure.
The input is the structured generated text and its associated display data, and the output is one or more stored records in the database that can be retrieved later.
The server writes the generated output to a dedicated table or collection, stores references to original transcripts and emotion records, and commits the transaction.
Step 16:
The server transmits display data and notification information to the terminal and to an information sharing device.
The server packages the display data and a notification message including a title, an identifier, and a timestamp, and sends them to the terminal using a network protocol; the server also prepares a message for an information sharing device, such as a collaboration service, and sends the generated summary or meeting record information through an application programming interface.
The input is the stored display data and generated output, and the output is delivered messages and notifications at the terminal and the information sharing device.
The server converts the data into a format accepted by client applications, such as a structured payload describing text content and emotion indices, and transmits it to registered recipients.
Step 17:
The terminal receives display data and renders the generated information to the user.
The terminal parses the received payload, extracts text content, emotion indices, and layout instructions, and updates the user interface on its display device.
The input is the display data and notification information from the server, and the output is a rendered view on the terminal's screen showing summary information or meeting record information with visual emotion indicators.
The terminal draws text segments, applies color coding or icons corresponding to emotion indices, and allows the user to scroll, read, and, if permitted, edit the presented content.
Step 18:
The user reviews the generated information and optionally provides feedback or initiates further processing.
The user reads the displayed summary information or meeting record information and checks the associated emotion indices for correctness or usefulness.
The input is the visual representation of the generated output on the terminal, and the output is user actions such as confirming, editing, or requesting a revised summary.
The terminal sends any user edits or additional requests back to the server, which may trigger re-processing, such as generating a shorter summary through a new prompt sentence or updating stored records to reflect user corrections.

The data generation model 58 is a so-called generative artificial intelligence (AI). Examples of the data generation model 58 include generative AIs such as ChatGPT (registered trademark) (Internet search <URL: https: //openai. com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

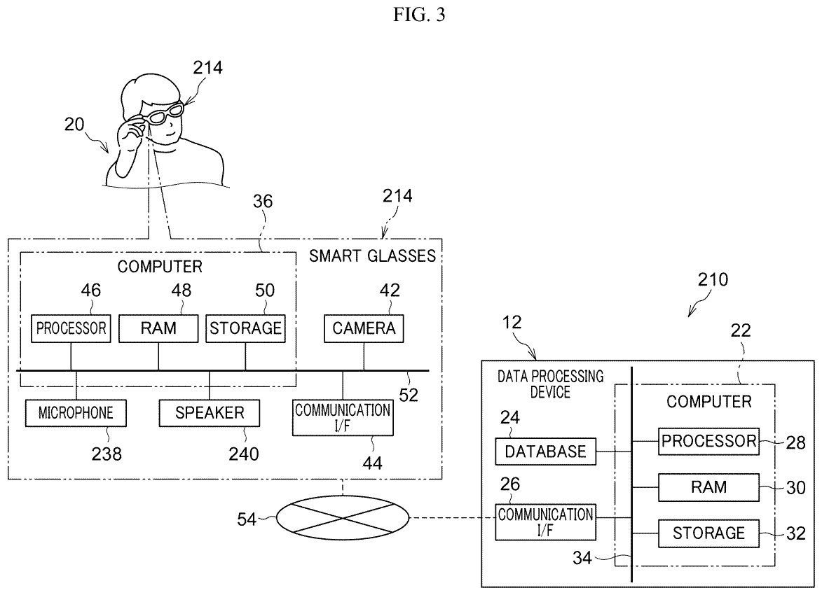

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

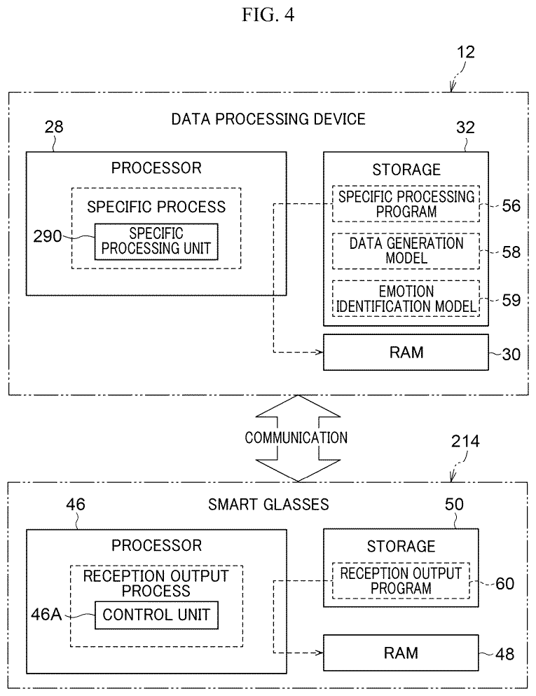

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

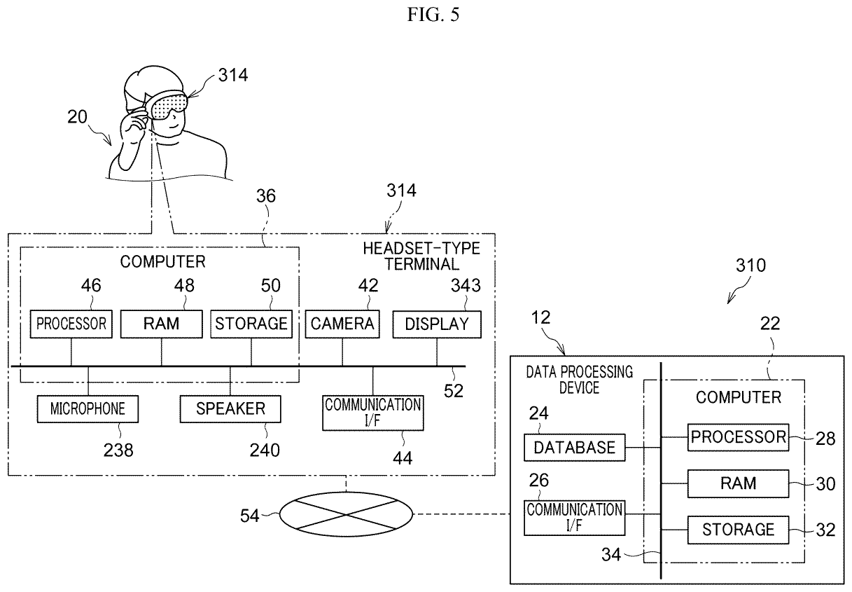

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

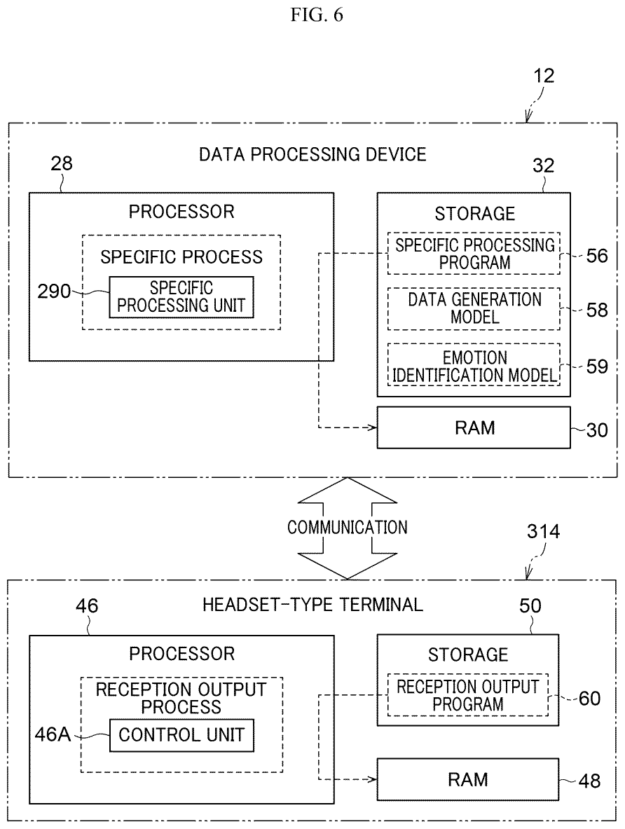

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

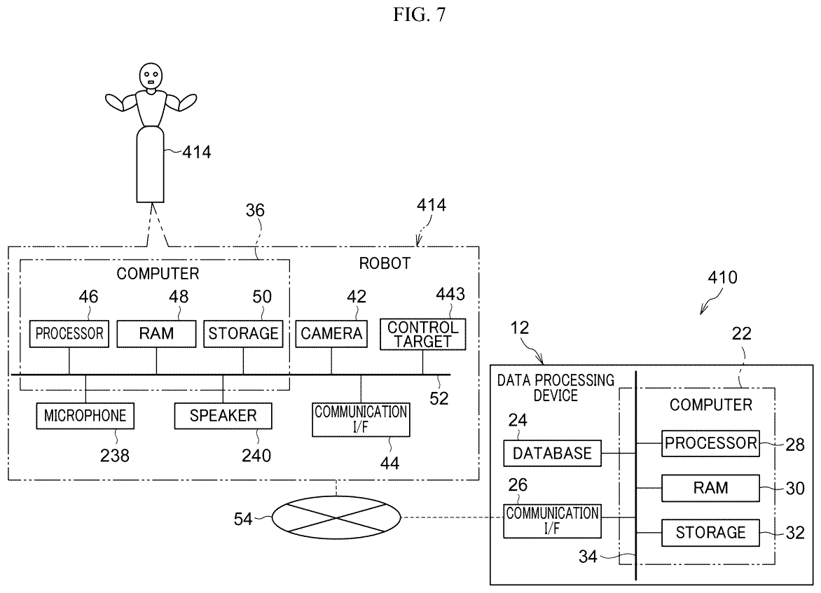

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

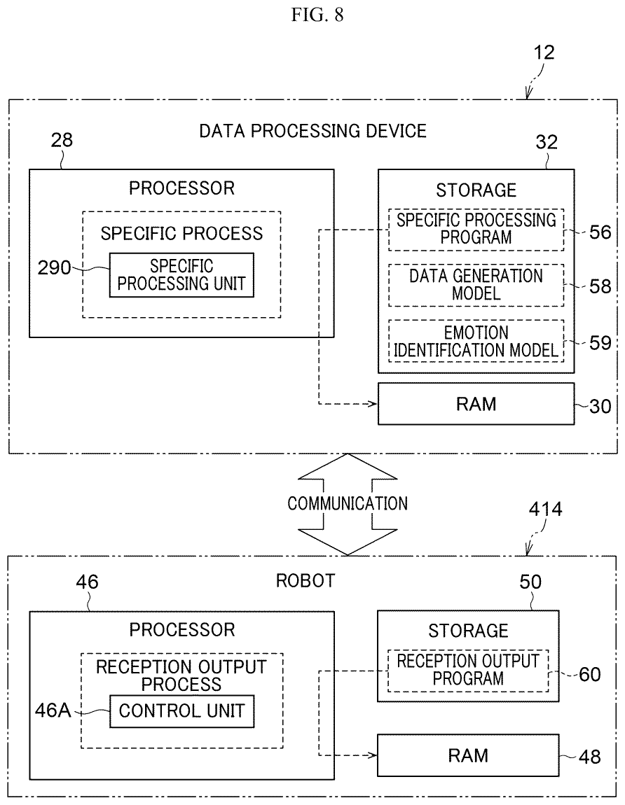

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

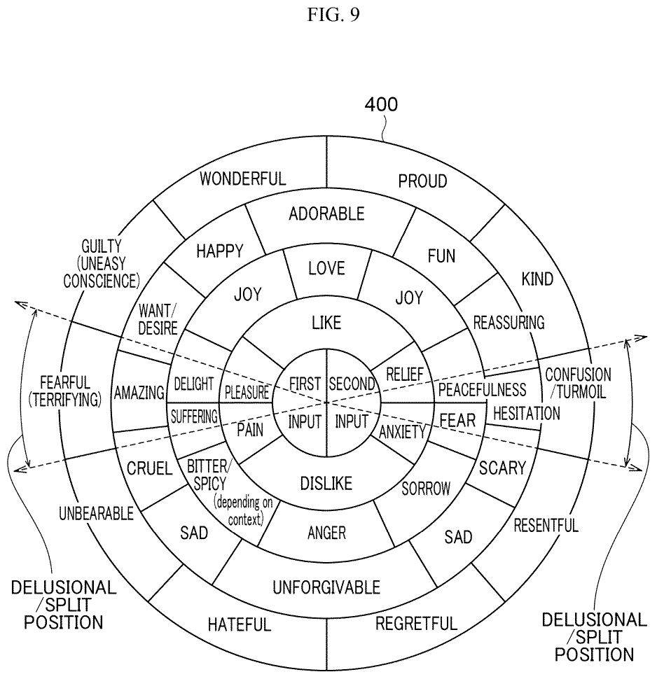

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

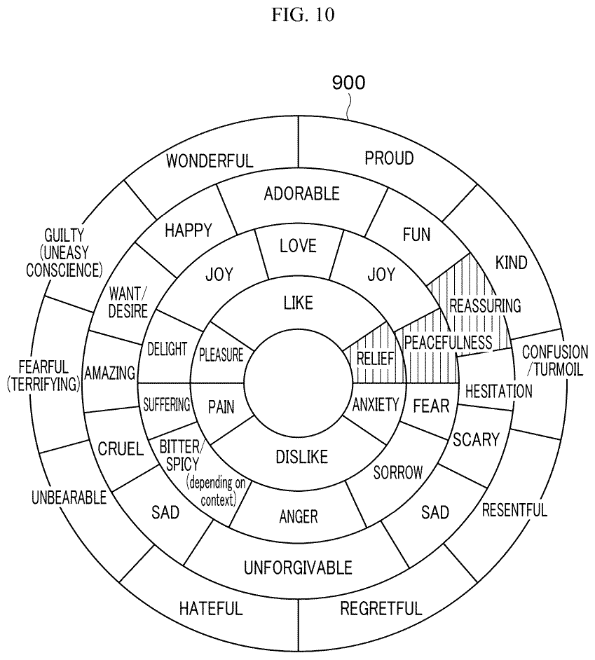

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to acquire audio information representing a communication event, execute speech recognition processing on the audio information, and convert the audio information into character information,
store the character information and attribute information associated with the audio information, including at least an identifier of the communication event, temporal information, and participant information, as structured information in a storage device, acquire, from the storage device, the character information corresponding to the communication event, and dynamically generate a prompt sentence to be input to a generative AI model in accordance with at least one of a length and a content of the character information,
input the prompt sentence and the character information into the generative AI model, and cause the generative AI model to generate at least one of summary information and additional analysis information based on the character information,
store the generated summary information and the additional analysis information in the storage device in association with identification information of the communication event, transmit, through a communication network and on the basis of destination information associated with a user terminal device, the generated summary information and the additional analysis information as notification information for immediate distribution to the user terminal device, and
receive, from the user terminal device, request information including an additional prompt sentence defining additional analysis conditions for the character information, reacquire, from the storage device, the character information corresponding to the communication event, and input the reacquired character information together with the additional prompt sentence into the generative AI model to regenerate the additional analysis information.

### Supplementary 2

The system according to supplementary 1,
wherein the processor is configured to control generation of the prompt sentence to be input to the generative AI model such that the prompt sentence includes instruction information specifying at least one of a format of the summary information, an amount of the summary information, a target range of the summary information, action items to be extracted, and unresolved matters to be extracted.

### Supplementary 3

The system according to supplementary 1,
wherein the processor is configured to generate the summary information and the additional analysis information as structured data suitable for display control by the user terminal device, and to transmit, to the user terminal device, display control information including the structured data that causes the user terminal device to display at least one of decisions, action items, and matters to be considered in a subsequent communication event in a distinguishable manner.

### Application Example 1

### Supplementary 1

A system comprising a processor,
wherein the processor is configured to acquire audio information and convert the audio information into character information by using a speech recognition technique,
store the character information in a storage device and manage the character information in association with time information corresponding to the audio information,
generate, for at least a part of the stored character information, a prompt sentence including an instruction statement specifying at least one of summarization conditions and expression conditions, and supply the prompt sentence together with the character information as input information to a generative AI model,
obtain summarized character information output from the generative AI model in response to the prompt sentence, and manage the summarized character information in association with a playback position of the audio information on the basis of the time information,
sequentially transmit the summarized character information and the character information to a terminal device via a communication path so that the summarized character information and the character information are displayed on the terminal device in synchronization with reproduction of the audio information, and
generate notification information for sharing at least one of the summarized character information and the character information in real time with another device or another user, and transmit the notification information via the communication path.

### Supplementary 2

The system according to supplementary 1,
wherein the processor is configured to control the terminal device to analyze the summarized character information and the character information received from the system, and to display the summarized character information and the character information in a caption region and a summary region within a display area in synchronization with a playback time of the audio information being reproduced, and transmit control information to the system so as to change generation conditions of the prompt sentence in accordance with at least one of summarization conditions and translation conditions input by a user through the terminal device.

### Supplementary 3

The system according to supplementary 1,
wherein the processor is configured to change the instruction statement included in the prompt sentence on the basis of at least one of summarization conditions, explanation conditions, and translation conditions input by a user via the terminal device, and generate and input to the generative AI model the prompt sentence that instructs the generative AI model to execute at least one of summarization, simplified explanation, and translation summarization of the character information.

### Example 2

### Supplementary 1

A system comprising a processor,
wherein the processor is configured to acquire audio information and convert the audio information into character information by using a speech recognition technique,
store the character information and identification information related to the audio information in a storage medium,
divide the character information into a plurality of character information groups according to an amount and content of the character information, and normalize each of the character information groups into a format acceptable as input to a generative AI model that performs natural language processing,
generate, for each of the character information groups, a prompt sentence including an instruction sentence specifying a summarization target and a summarization style and including the corresponding character information group, and input the prompt sentence into the generative AI model to cause the generative AI model to generate summary character information corresponding to each of the character information groups,
integrate the summary character information acquired from the generative AI model and structure the integrated summary character information as meeting summary information including decision information, task item information, and deadline information,
register the meeting summary information in an information management apparatus in association with the character information and the identification information, and generate index information to be used for a search process or a reference process,
specify distribution destination information including shared-person information on the basis of the meeting summary information, and generate a message in a notification format according to the distribution destination information, and
transmit the message to an information processing terminal via a communication network in real time, and provide the meeting summary information so as to be viewable on the information processing terminal.

### Supplementary 2

The system according to supplementary 1,
wherein the processor is configured to generate the prompt sentence on the basis of summarization request information input by a user and on the basis of the character information or character information input from an external apparatus, the prompt sentence including an instruction sentence defining a summarization range, a summarization length, and an expression style and including the character information, and input the prompt sentence into the generative AI model to cause the generative AI model to generate summary character information according to the summarization request information.

### Supplementary 3

The system according to supplementary 1,
wherein the processor is configured to generate, as the message, notification information including outline information obtained by extracting a part of the meeting summary information and including reference information for accessing at least one of the meeting summary information and the character information, and perform real-time notification to the information processing terminal by using the notification information.

### Application Example 2

### Supplementary 1

A system comprising a processor,
wherein the processor is configured to acquire audio information,
convert the audio information into character information by executing a speech recognition process,
store the character information in a storage device,
execute an emotion analysis process on the character information to extract emotion information,
generate a prompt sentence for instructing a generative information processing model to generate summary information or meeting record information on the basis of the character information and the emotion information,
input the prompt sentence and the character information into the generative information processing model so that the generative information processing model generates the summary information or the meeting record information,
transmit the summary information or the meeting record information and the emotion information to a display device so that the summary information or the meeting record information and the emotion information are displayed,
transmit the summary information or the meeting record information and the emotion information to an information sharing device having a communication function so that the summary information or the meeting record information and the emotion information are shared in real time, and
notify a user terminal of the summary information or the meeting record information.

### Supplementary 2

The system according to supplementary 1,
wherein the processor is configured to generate the prompt sentence by acquiring, from the storage device, the character information and the emotion information, and by embedding, into the prompt sentence, context information including a portion of the character information selected according to an importance degree of the character information and an outline of the emotion information, so as to instruct the generative information processing model to generate the summary information or the meeting record information reflecting the emotion information.

### Supplementary 3

The system according to supplementary 1,
wherein the processor is configured to generate display data in which an emotion index corresponding to the emotion information is added to each part of the summary information or the meeting record information, and to transmit the display data to the user terminal so that the summary information or the meeting record information and the emotion index are displayed simultaneously on the user terminal.

What is claimed is:

1. A system comprising:
circuitry configured to:
acquire, via a communication interface coupled to a packet-switched network, audio data from a terminal device, execute speech recognition processing on the audio data by extracting acoustic feature vectors and decoding the acoustic feature vectors using a neural network acoustic model and a language model to generate character information;
structure and store the character information in an information storage device in association with attribute information comprising an event identifier, temporal information, and participant information, the character information being stored as indexed records enabling retrieval by event identifier and temporal range;
dynamically generate a prompt sentence based on at least one of a length and a content of the character information, the prompt sentence comprising an instruction specification defining at least an output format, an output scope, and extraction targets, and transmit the prompt sentence and the character information to a generative neural network model comprising a transformer-based architecture to acquire at least one of summary information and analysis information;
parse the summary information and the analysis information to extract structured data elements comprising decision data, task item data, and temporal constraint data, and store the structured data elements in the information storage device in association with the event identifier;
generate notification data comprising the structured data elements formatted as display control information that distinguishes the decision data, the task item data, and the temporal constraint data, and transmit the notification data to one or more terminal devices via the communication interface; and
acquire, from a terminal device, request information comprising an additional prompt sentence defining additional analysis conditions, reacquire the character information from the information storage device, construct a composite prompt sentence combining the additional prompt sentence with system-level instruction data, and transmit the composite prompt sentence to the generative neural network model to acquire updated analysis information.

2. The system according to claim 1, wherein the speech recognition processing further comprises segmenting the audio data into fixed-length frames, computing mel-frequency cepstral coefficient features or log-mel spectrogram features from the frames, and decoding output probability distributions using a beam search algorithm with a vocabulary of subword units.

3. The system according to claim 2, wherein the circuitry is further configured to execute speaker diarization on the audio data by computing speaker embedding vectors from audio segments and clustering the speaker embedding vectors to assign speaker identifiers to respective segments of the character information.

4. The system according to claim 1, wherein the circuitry dynamically generates the prompt sentence by analyzing the character information to determine a total token count, a number of segments, a distribution of participant turns, and presence of domain-specific keywords, and selecting a prompt template and generation parameters based on the determined properties.

5. The system according to claim 4, wherein the circuitry is further configured to estimate a token count of the prompt sentence and the character information, and when the estimated token count exceeds a context window limit of the generative neural network model, select or compress segments of the character information based on relevance scores to remain within the context window limit.

6. The system according to claim 1, wherein the circuitry is further configured to divide the character information into a plurality of character information groups based on a token count threshold and semantic boundary detection, normalize each character information group into a format acceptable by the generative neural network model, generate a respective prompt sentence for each character information group, and merge the resulting summary information segments into consolidated summary information.

7. The system according to claim 6, wherein the normalization comprises converting characters to a target encoding, removing unsupported control characters, standardizing punctuation, and inserting structural delimiters between logical sections.

8. The system according to claim 1, wherein the structured data elements further comprise index information mapping key terms, entity names, and temporal values to record identifiers of the summary information and the character information, the index information enabling search and reference processes on the stored data.

9. The system according to claim 1, wherein the notification data further comprises outline information extracted from the structured data elements and reference information comprising an identifier or address enabling a terminal device to retrieve full summary information from the information storage device.

10. The system according to claim 1, wherein the circuitry is further configured to manage the character information and the summary information in a time-indexed data structure that associates each segment with a start timestamp and an end timestamp, enabling retrieval of text segments aligned with a playback position of the audio data.

11. The system according to claim 10, wherein the circuitry is further configured to transmit the character information and the summary information to a terminal device in synchronization with reproduction of the audio data, such that the terminal device displays the character information in a caption region and the summary information in a summary region.

12. The system according to claim 11, wherein the circuitry is further configured to adapt the prompt sentence based on user preference data received from the terminal device specifying at least one of summarization conditions, explanation conditions, translation conditions, and expression conditions.

13. The system according to claim 1, wherein the circuitry is further configured to execute an emotion analysis process on the character information by converting segments into feature representations and inputting the feature representations into a neural network emotion classifier to compute emotion score data comprising emotion category labels and intensity values.

14. The system according to claim 13, wherein the circuitry is further configured to embed context information comprising a portion of the character information selected according to an importance degree and an outline of the emotion score data into the prompt sentence, such that the generative neural network model generates summary information reflecting emotional state data.

15. The system according to claim 14, wherein the circuitry is further configured to generate display data in which an emotion index corresponding to the emotion score data is associated with each portion of the summary information, and transmit the display data to the terminal device for simultaneous display of the summary information and the emotion index.

16. The system according to claim 13, wherein the importance degree is computed for each segment based on a weighted combination of term frequency, presence of key phrases, segment position, and magnitude of the emotion score data, and the circuitry selects segments having highest importance degrees within a token budget for the generative neural network model.

17. The system according to claim 1, wherein the audio data represents a meeting, the decision data comprises agreed-upon conclusions, the task item data comprises assigned responsibilities with due dates, and the notification data comprises meeting minutes formatted for distribution to participants.

18. A system comprising:
circuitry configured to:
acquire audio data via a communication interface, execute speech recognition processing on the audio data to generate character information, and store the character information in an information storage device in association with attribute information;
dynamically generate a prompt sentence based on properties of the character information and transmit the prompt sentence to a generative neural network model to acquire summary information;
parse the summary information to extract structured data elements comprising decision data, task item data, and temporal constraint data;
generate notification data comprising the structured data elements and transmit the notification data to a terminal device; and
acquire an additional prompt sentence from the terminal device, reacquire the character information, and transmit a composite prompt sentence to the generative neural network model to acquire updated analysis information.

19. The system according to claim 18, wherein the circuitry is further configured to execute an emotion analysis process on the character information to compute emotion score data, and embed the emotion score data into the prompt sentence to generate summary information reflecting emotional state data.

20. A method performed by circuitry via a communication interface coupled to a packet-switched network, the method comprising:
acquiring audio data from a terminal device and executing speech recognition processing on the audio data by extracting acoustic feature vectors and decoding the acoustic feature vectors using a neural network acoustic model to generate character information;
structuring and storing the character information in an information storage device in association with attribute information comprising an event identifier and temporal information;
dynamically generating a prompt sentence based on at least one of a length and a content of the character information, the prompt sentence comprising an instruction specification defining an output format and extraction targets, and transmitting the prompt sentence to a generative neural network model comprising a transformer-based architecture to acquire summary information;
parsing the summary information to extract structured data elements comprising decision data, task item data, and temporal constraint data;
generating notification data comprising the structured data elements and transmitting the notification data to one or more terminal devices; and
acquiring an additional prompt sentence from a terminal device, reacquiring the character information, and transmitting a composite prompt sentence to the generative neural network model to acquire updated analysis information.
